(19) United States
(12) Patent Application Publication
(10) Pub. No.: US 2013/0117060 A1
(43) Pub. Date: May 9, 2013

(54) System for Collaboration and Meeting Management

(71) Applicants: Thomas B. Henriksen, Skanderborg (DK); Thomas Toftborg, Galten (DK); Adam Martingano, Indialantic, FL (US); Ulrik Merrild, Tampa, FL (US)

(72) Inventors: Thomas B. Henriksen, Skanderborg (DK); Thomas Toftborg, Galten (DK); Adam Martingano, Indialantic, FL (US); Ulrik Merrild, Tampa, FL (US)

(73) Assignee: MatchWare A/S, Aarhus (DK)

(21) Appl. No.: 13/291,099

(22) Filed: Nov. 8, 2011

(51) Int. Cl. G06Q 10/06

(52) U.S. Cl. 705/7.21

(57) ABSTRACT

Computer hardware and software implement a mind mapping system and method for collaboration. Each branch is assigned an identifier by the system, and each child branch is assigned a child identifier. The child identifier includes a reference to the identifier of the branch from which the child branch extends. An external export system may export information to external project management systems. An input system may receive changes to parameters, determining if changes should be made and rejecting changes for lack of permissions. A system may automatically generate a meeting agenda from tasks that may be created during mind mapping incorporating automatic generation of a meeting agenda, automatic optimization of the meeting agenda, automatic conduct of a meeting and automatic generation of a dashboard including information obtained from the system and feedback and switching between viewing projects in a mind map agenda view or a project management view.

### RELATED APPLICATIONS

This application claims priority to U.S. Prov. Appl. No. 61/410,604, filed Nov. 5, 2011, the entire disclosure of which is incorporated by reference herein in its entirety.

### FIELD OF THE INVENTION

The field relates to computer systems implementing mind mapping, which is a tool used in collaborative projects for planning and exploration of creative solutions, and to automated meeting management programs implemented on computer systems.

### BACKGROUND

A mind map is a tool that consists of a diagram of words linked to and arranged around, sometimes randomly, a central topic. It is useful in the creative arts, project planning and collaborative decision making. The tool is useful in visualizing, structuring and classifying ideas related to a central topic. Computer applications and systems have been devised to assist in the mechanics of the process of using a mind mapping tool, but generally, these systems do not change, substantially, the usefulness or results achieved using the tool compared to use of mechanical devices, such as a white board or butcher block pad.

In U.S. Pat. Pub. No. 2003/0233631, published Dec. 18, 2003, a mind map is shown in FIG. 4A. This mind map is used to define and capture the roles and scope of each role in a web-based application or business solution. This mind map is used to prepare specifications for a project to generate the web-based application. Four main branches are defined: contributor, user, editor and moderator. Each of these branches have additional branches that define the “I wants” of each of these four main branches.

In U.S. Pat. Pub. No. 2007/0190503, published Aug. 16, 2007, mind mapping is disclosed as a method of learning in which individuals use a process to recognize both the content and the structure of their own thinking. This traditional mind mapping technique provides recursive expansion of thought processes, which identify the branches and structure in the thought processes of an individual, allowing the individual to examine his or her individual thinking and to discern how meaning is codified by an individual at a particular moment in time. This thinking about thinking is termed meta-cognition by the authors and is applied to individual learning and self selection.

U.S. Pat. Pub. No. 2002/0049689, published Apr. 25, 2002, describes an example of a mind map in FIG. 3.2 that links words related to central ideas, with a certain number of links between central ideas. This publication teaches away from such unstructured hypertextual linking, without context, because the starting point concept keeps changing and the structure, itself, keeps changing with the hypertext movement. Furthermore, the mind map is flat, two-dimensional and rigid and does not acknowledge perspective of the viewer of the mind map. The traditional mind map, according to the publication, is woefully a contextual. Therefore, the process of selecting appropriate concept, building linkages and determining the content or knowledge inputs to be populated within each concept is not a well-defined process but is an art, requiring expert assistance. Instead, this publication proposes a sort of personalized search engine that provides links to topics of interest identified through an initial search.

Microsoft® Access® is an example of a software program that operates on a computer system to allow a user to create a relational database.¹ Microsoft® Visio® is an example of a software program that operates on a computer and allows mind mapping, presenting hierarchical bubble diagrams in a module referred to as brainstorming.¹ ¹ Microsoft® Access® and Visio® are registered trademarks of Microsoft Corporation.

However, none of these issued patents or publications or any other known systems provides the tools and types of structures needed to collaboratively achieve desired goals as efficiently and effectively as disclosed herein. Indeed, the advantages of the examples disclosed are surprising and unexpected in this industry providing a synergistic system of tools and data structures that yields benefits in combination that are much greater than the sum of the individual components of the system including new features unavailable in known systems.

### SUMMARY

A system for collaboration and meeting management comprises a computer, which may include one or more processors, memory storage devices, registers, database structures, input devices, output devices and the like, which may be centralized, distributed on a network or otherwise. A processor of the system receives instructions stored in a memory location of the system and accesses data from a memory storage device or devices. The data may be stored in a database structure, such as a relational database, for example. The architecture of the computer is well known and may include virtual processors and virtual storage distributed on more than one computer system and more than one storage medium.

Based on this written description, a person having ordinary skill in the art of computer programming, using available programming tools, may implement a system including the features of the examples disclosed without undue experimentation. Object oriented, graphical software tools allow such a person to generate the screens displayed in the examples, and database programming tools allow such a person to generate the necessary database structures. Nevertheless, the implementation of interoperable features disclosed in the examples is new and nonobvious over known systems, when implemented in the system arrangements described and claimed.

Any one or more of several available programming languages may be used to implement examples of the system in conjunction with objected oriented design principles and database structures, such as C++, scripting languages, relational databases and existing programming environments. The software development of the various screen shots and flow diagrams is within the skill of a team of programmers having ordinary skill in the art of software development. Any of a variety of database solutions may be included in implementing a system as are very well known in the industry, such as relational database programming libraries and environments for defining and controlling a database structure capable of storing and sharing data from the database as disclosed herein.

For example, a mind mapping system according to one example provides a structured system for collaborative project planning and plan execution. A mind mapping system may implement a method for creating, distributing and tracking task and process information. In one example, the system includes a mind mapping system, and the mind mapping system is capable of creating a mind map. Known mind maps include at least one core idea and branches extending from the core idea.

In one example, each branch is assigned a unique identifier (Branch ID), and each branch may correspond to and define a task or tasks, together with the requirements necessary to complete such task or tasks. Each branch may relate to additional branches that extend from the task or tasks defined by the Branch ID, and these child branches are assigned unique identifiers, which may be referenced to the Branch ID of the parent branch, for example.

A task in a project management mind mapping system may be defined as an individual classifying topic, for example, which may be created to describe activities deemed necessary to complete project requirements.

An organizer of the project may be allowed to control the mind mapping system, or the system may allow the organizer and others to cooperatively control all or portions of the mind mapping system. A computer interface is provided that is capable of control of the mind mapping system by a user interacting with the input/output devices of the computer.

For example, the organizer may be allowed to convert each Branch ID into a task. The task may be defined by the organizer by certain parameters. These parameters may include task scheduling and distribution values, such as duration, start date, end date, priority, completion and allocated resources. These values may be visually displayed in a branched, hypertextual mind map accessible by those selected to have access to specific ones of the Branch ID's, for example. Access may be provided to read and/or change all or portions of the information in a particular Branch ID or Branch ID's.

In one example, the system allows the organizer to export and/or integrate the structure of the branched, hypertextual mind map into an external project management or task tracking system. For example, the system exports tasks to the task tracking systems of Microsoft Outlook or Lotus Notes, populating these popular calendaring and scheduling systems with tasks and values for individuals that are assigned to specific Branch ID's, for example, transforming these popular calendaring and scheduling systems into distributed project management tools. It is known in the art how to export task scheduling to such popular calendaring and scheduling systems. Examples are provided in software development kits and by the purveyors of the popular calendaring and scheduling systems.

For example, interfacing with the Outlook® automation interface is shown at http://support.microsoft.com/?kbid=220600, which is incorporated herein by reference in its entirety.

In one example, the organizer defines a resource task list, identifying electronic identifiers, such as unique email addresses, of human resources assigned to a specific Branch ID. For example, the organizer is permitted to distribute tasks to individuals using the unique email address assigned to the individual, based on the resources allocated by the organizer to a specific Branch ID in the mind mapping system. The external task tracking system is updated with the respective values assigned as parameters by the organizer in the mind mapping system.

In one example, an individual receiving such information may be authorized to change some or all of the values in the external task tracking system, such as duration, start date, end date, priority, completion and resources, and feedback will be provided to the system of mind mapping. For example, the system of mind mapping may update the system with the changes made by an individual in the external task tracking system and may automatically update other values in the system of mind mapping to accommodate the changes by the individual in their own task tracking system. For example, the values, such as duration, start date, end date, priority and resources, of a Branch ID and/or a child of a Branch ID and/or a parent of a Branch ID may be updated by the system of mind mapping, automatically, when an individual updates values related to a different Branch ID or a parent or child of a Branch ID. The system of mind mapping may automatically export these new values according to the allocated resources entered into the mind mapping system. These values may be modified by receiving individuals, who are permitted to change the values, in their particular task tracking system, which may recursively update the mind mapping system, automatically adjusting and updating the external task tracking systems of the individuals allocated as resources by the mind mapping system.

In one system, each individual allocated as a resource in a unique Branch ID accesses an external task tracking system on a computer. The external task tracking system may be any of the popular systems available from third parties. The mind mapping system may reside on an organizer's computer, server or through a third party website providing software as a service. The mind mapping system may operate according to the rules of one of the known mind mapping utilities that permits structuring of projects by mind mapping techniques, such as MindView™². For example, this permits distributed, cloud task scheduling and synchronization using resources available to users using popular calendaring and scheduling software. ² MindView is a trademark of MatchWare.

In one example, certain of the Branch ID's may be locked by the organizer. By locking the Branch ID, the organizer can prevent the values entered by the organizer in the Branch ID from being changed by individuals allocated as resources in the locked Branch ID or other Branch ID's. Alternatively, only certain values in a Branch ID may be locked to prevent automatic changing of the values. In either alternative, an attempted change of locked values or values of a locked Branch ID may generate an email from an individual allocated as a resource by an organizer, and an email may be generated by the system of mind mapping, automatically, informing the individual that the value is locked and changing the value back to the locked value. Feedback may be given to the organizer of the attempt to change locked parameters and the nature of the change to the value that was attempted by one of the individuals allocated as a resource. In this way, the organizer may become aware of an issue that needs to be addressed, while positively controlling a project being managed by the system of mind mapping.

In one example, the organizer may assign particular individuals to be able to change particular values in a Branch ID. For example, an individual may be able assigned permission to update values in one Branch ID, but may be restricted from causing changes in values in one or more locked Branch ID's. For example, any changes made in a Branch ID by an individual, in which the individual is allocated as a resource in the Branch ID and is given permission to make any changes, may generate an email that returns the changes to the mind mapping system. The mind mapping system may determine if the individual is permitted to make the changes, will automatically check the values to see if the change affects only one Branch ID or will affect other Branch ID's, necessarily or permissively, and will determine if the individual has permission to change values in the other Branch ID's. If permitted, then the change may be made automatically by the system of mind mapping. If not permitted or if the change would affect, necessarily, the values of a locked Branch ID, to which the individual is not granted permissions, then the change may be rejected by the mind mapping system. For example, an individual may be permitted to indicate when a task associated with a unique Branch ID is completed, and this may be updated in the mind mapping system, but the same individual may not be permitted to change the end date or deadline set in the mind mapping system.

In one example, as only the organizer has access to and control over the mind mapping system, the system of mind mapping provides a secure, distributed task scheduling and control environment. In one example, the mind mapping system may push values to distributed individuals identified as allocated resources in one of the Branch ID's from time to time, ensuring that external task tracking software of the individual is current and is receiving email from the mind mapping system.

In one example, the system utilizes a shared workspace, which is an online system created to host and share interactive document files. For example a shared workspace may include one or more online systems, such as Microsoft SharePoint™, Microsoft Live™, or Google Docs™ for sharing interactive files, such as MatchWare MindView™ files, Microsoft Office™ files, Adobe Acrobat™, Google Docs™ files and the like. Information about a task may be updated in a resource's task view, within a shared workspace or within distributed mind mapping systems operating on remote processors, and both the shared workspace and the distributed mind mapping systems may be updated by synchronization, for example. hi this example, individuals given permission to certain Branch ID's may update parameters associated with the permitted Branch ID's but may be prevented from updating parameters in certain locked Branch ID's. Using a shared workspace reduces the overhead and may reduce errors associated with email distribution of changes to values made by individuals. Using the shared workspace, the individuals allocated as resources in the mind map system still may be sent email that updates their local task scheduling software, for example, but collaboration on documents and changes to the values in a Branch ID would be made in the shared workspace or synchronized by the shared workspace. The notification email may provide a link to a resource that the resource may click on to access a mind map document in the shared workspace. The originator may be provided control over who has read and/or write access to the document or to particular branches in the document and when the access is provided. The system may provide write access to one or more resources during a collaborative editing of a mind map document accessed by a plurality of individuals in a common shared workspace, for example.

The system may include a meeting management system, which may be resident on a server coupled with a database and an application, for example. In one example, a method for collaboration and meeting management uses the system. The system may comprise the steps of implementing a mind mapping method comprising creating a visual mind map of a plurality of branches of a mind map generated in the mind mapping system; assigning a unique identifier for each branch of the plurality of branches, extending one or more child branches from each branch in the visual mind map, and assigning a unique child identifier to each of the one or more child branches, such that the unique child identifier includes a reference to the unique identifier of the branch from which the child branch is extending; allowing input from an organizer of a project to control the mind mapping system, such that the mind mapping method converts each unique identifier into a task of the project, and storing a plurality of parameters in a database such that the plurality of parameters include a value for task scheduling and a value for task distribution to at least one allocated resource; visually displaying a branched, hypertextual mind map on an output device, and permitting the at least one allocated resource to change one of the plurality of parameters arranged in the database structure based on the value for task distribution; providing a shared workspace for collaborative mind mapping of each of the tasks; and exporting each of the tasks to an external project management or task tracking system of the at least one allocated resource, according to the value for task distribution and data contained in the value for scheduling, such that the data is received by the external project management or task tracking system in a format compatible with the external project management or task tracking system.

In one example, the method further comprises receiving changes from the external project management or task tracking system of the at least one allocated resource, when changes are made in the external project management or task tracking system by any of the at least one resource within the external project management or task tracking structure, and/or processing the changes received in the step of receiving by checking the value for task distribution and determining if the value for task distribution permits the at least one allocated resource to make the changes received in the step of receiving changes. For example, a step of processing the changes may include preventing the change and informing the at least one resource that the value is locked, when the at least one resource is not permitted to make changes to the value or values according to the value for distribution. A method may further comprise returning the value or values changed in the external project management or task tracking system back to the unchanged value or values, when the at least one resource is not permitted to make the changes to the value or values according to one or more of the values for distribution, for example. For example, a step of notifying the organizer of an attempt to change parameters may be included if the value for task distribution permits the at least one allocated resource to make the changes received in the step of receiving changes. The step of notifying may include describing the nature of the change to the parameters that was attempted in order to inform the organizer of an issue raised by one of the assigned resources.

In one example, particular ones of the at least one resources are permitted to make changes to particular ones of the plurality of parameters. The step of permitting particular ones may allow different changes by the at least one allocated resource in the shared workspace for collaborative mind mapping than the changes allowed in the external project management or task tracking system, for example. In this way, the collaborative process in a shared workspace may be more fluid than the automated process in a distributed system utilizing external project management or task tracking systems, which may require additional controls to prevent unauthorized changes from occurring without careful scrutiny by the supervisor of the overall project. Controls may be implemented to allow only one or a few trusted individuals to make changes to some of the project parameters identified in the system.

In one example, the system may receive an email from the external project management or task tracking system whenever a resource makes a change in one or more of the plurality of parameters within the external project management or task scheduling system. Then the system may include a step of determining if the resource is permitted to make the particular change to the particular parameter, such as the value for task scheduling, for example. The step of determining may include automatically checking the particular one of the values for scheduling to determine if the change affects only one task identified by a unique identifier or will affect other tasks, and may determine if the at least one resource has permission to change the other tasks, when the change will affect other tasks, and permitting the change to the value for scheduling only when the step of determining determines that the at least one resource has permission to change both the value of scheduling for the task identified by the unique identifier or unique child identifier and the value of scheduling for any other tasks.

A method may further comprise a step of rejecting any change made when the step of determining values determines that the change will affect other tasks and the particular resource is not permitted by default rules or rules entered by the organizer to make changes to tasks in one or more of the other tasks that would be impacted by the change made by the resource. The change may be rejected if the change would alter, necessarily, a secondary value in a branch associated with a unique identifier or unique child identifier to which the at least one resource making the change is not granted permissions to change the secondary value, for example. For example, a value relating to task completion may be entered by the resource, such as an entry showing that one or more task or sub-tasks have been completed. If authorized in the system to update the value related to task completion, the system may automatically update both the completion status and a start time for another task that is dependant on the value relating to task completion entered by the authorized resource.

A method of meeting management may be implemented within a system of collaboration and meeting management. For example, the method of meeting management comprises creating a meeting agenda in the mind mapping system by implementing a mind mapping method for generating a plurality of topics as branches in the mind mapping system, and assigning the unique identifier to the branches and the unique child identifier to sub-topics within each of the plurality of topics, if any, and saving the meeting agenda in the database. The step of creating may provide for inputting of a title, a start time and a duration for each of the plurality of topics, such that if the title, the start time and the duration are input for any of the plurality of topics. The value for task scheduling for the particular one of the plurality of topics may include any of the title, the start time and the duration for each of the plurality of topics input in the step of creating and for sub-topics or portions of topics and the like. Topics may include fixed start times, end times or durations, for example, and may be allowed to be split or may not be allowed to be split. In one example, a default rule is provided that allows topics to be split at sub-topics, unless a rule is established for the topic or for the particular sub-topic or sub-topics preventing splitting of the sub-topic or sub-topics. Splitting of sub-topics from non-fixed topics may be used by the system to automatically fill gaps between fixed start or end times of topics, for example. Alternatively, duration of non-fixed or fixed topics may be extended or decreased to fit topics within the length of an agenda, or the system may provide a notification of a problem with the number and duration of topics or the time allocated for the meeting agenda, if topics cannot be fit into the agenda.

A meeting editing system may be displayed in either mind map or agenda mode allowing amending of the title, the start time or the duration for any of the plurality of topics, including adding or changing information related to any sub-topics within each of the plurality of topics. Alternatively, a step of a method may first check automatically to see if there is time available in the schedule for filling a time gap between a meeting start time and a first fixed topic and may insert a break between the meeting start time and the topic start time if there is sufficient time in the schedule, before determining if a topic or portion thereof, such as a sub-topic, should be moved to fill the time gap, for example, or may first check to see if a non-fixed topic or sub-topic fits in the particular time gap before entering a break. Default and custom rules may be adopted to define the preferences and order of steps in the method, for example. Also, the system may move the start time of the meeting, if allowed, to correspond to the first fixed topic, if the organizer requires the first fixed topic to be the first topic in the meeting agenda. Likewise, a time gap might exist between two fixed topics, which start times, durations or end times may be fixed by the organizer or during a mind mapping exercise or later during editing of an agenda, based on availability of resources, for example. Then, the system may automatically check to see if there is time available in the meeting agenda schedule to allow the gap to be filled out as a break or if it is necessary to move one or more non-fixed topics or portions thereof, if permitted, to fill all or a portion of the time gap between two fixed topics. In this way the system may automatically optimize the meeting agenda prior to any need to manually adjust the number of topics and parameters of topics in the meeting agenda.

For example, the system may automatically distribute topics within an agenda based on rules within a system for distributing topics. The step of distributing topics may include calculating if the duration of one or more of the topics is greater than a time allocated for a meeting agenda, and prompting a user to make a change to the length of one or more of the topics, the time allocated for the meeting agenda or removing one or more of the topics from the view of the mind map or a view of the agenda, for example. If the step of calculating calculates that the duration of all of the topics is less than the time allocated for the meeting agenda, then the system may determine the remaining time of the meeting agenda not allocated to one or more of the topics, before determining if the remaining time is to be allocated automatically based on default rules or rules established by the organizer or others authorized to set such rules for the system. For example, if the remaining time is to be allocated automatically, then the system may automatically add time to particular ones of the plurality of topics based on the rules, such adding time equally to each of the topics or adding time proportionally to each of the topics based on the duration assigned to each of the topics. In one example, a topic with no assigned duration in the value for task scheduling may not have any time added during this first pass.

In one example, the meeting agenda may be adjusted by the system. For example, the step of adjusting the meeting agenda may include first sorting fixed topics having a fixed start time from non-fixed topics having no fixed start time, wherein the fixed topics may be sorted in order according to fixed start time from the earliest fixed start time to the latest fixed start time, for example. Then, if any non-fixed topics overlap any fixed topics, the system may determine if the non-fixed topics may be split based on the rules (or alternatively if extra time remains for inserting breaks). Splitting those non-fixed topics that may be split based on the rules and moving the non-fixed topics or split portions thereof to start after an end time of one of the fixed topics may be used to optimize the meeting agenda, using the time most efficiently. However, the system may contain rules about inserting breaks at certain minimum and maximum rules that may give a preference to inserting a break, as a “topic,” rather than inserting a topic or a portion thereof in a time gap.

In one example, the method may include comparing a start time assigned to a first topic of the plurality of topics in the meeting agenda and a start time for the meeting, and if the start time assigned to the first topic begins after the start time for the meeting, then if the start time assigned to the first topic may be changed to the meeting start time, changing the start time assigned to the first topic to the meeting start time. Alternatively, the meeting start time may first be changed to the start time of the first topic, if the meeting start time is allowed to be changed and the rules allow for first adjusting the meeting start time. If not, then if the duration between the meeting start time and the start time assigned to the first topic is sufficient to insert a non-fixed topic or portion thereof, if the non-fixed topic may be split based on the rules, then a method may change the start time of one of the non-fixed topics or portion thereof In this case, the time gap is filled with a non-fixed topic or portion thereof, such as a sub-topic, having a duration equal to or less than the duration between the meeting start time and the start time assigned to the first topic, for example. Otherwise, a break may be inserted between the meeting start time and the start time of the first topic and/or an alert or notification message may be displayed to notify of the lack of an automated solution for the time gap based on the rules used by the system.

For example, a step of adjusting the meeting agenda may include, if a time gap exists between an end time of any one topic and the start time of another topic, such as two adjacent fixed topics in a sequentially sorted list of fixed topics, and if the start time of the later topic may be changed based on the rules, then the method may change the start time of the later topic to begin earlier, when the duration of the first topic ends. Herein, it is understood that “when the duration of the first topic ends” includes any rule-based break required between topics by the system. For example, the system might require a one minute, five minute or ten minute break between topics or sub-topics. Alternatively, the system may not require any break between topics or may require a break of a particular duration whenever a maximum break-free duration is exceeded, such as every four hours, for example. Likewise, the system may require no breaks until a minimum break-free duration is exceeded, such as thirty minutes, for example.

If the start time of a topic may not be changed based on the rules, then if the duration between the end time of the one topic and the start time assigned to another topic is sufficient to insert a non-fixed topic or portion thereof, if splitting is allowed, then the method may change the start time of one of the non-fixed topics or portion thereof, if it has a duration equal to or less than the time gap between the end time of the first topic and the start time assigned to next topic. The non-fixed topic may be added to the end time of the first topic, for example, such that the time gap is filled or partially filled by the non-fixed topic. Otherwise, a break may be inserted between the first topic and the next topic following the first topic, for example. Each of the time gaps between one fixed topic and the following fixed topic may be filled with either a break or a non-fixed topic during this agenda optimization process, for example, by adjusting the start and end times of non-fixed topics or portions thereof, such as sub-topics, or by inserting breaks. The rules of the system may be adjusted to either first select breaks, if time is available for more breaks in the meeting agenda, or to first select non-fixed topics to fill the time gaps. In one example, breaks are first inserted and then the system allows the meeting agenda to be adjusted manually. In another example, the system is allowed to optimize the meeting structure by filling time gaps with topics and sub-topics first, if non-fixed topics or subtopics are provided without fixed start times and durations or end times.

In one example, the step of adjusting extends the duration of the non-fixed topic to end at the start time for the fixed topic, if a time gap exists between a non-fixed topic and a subsequent fixed topic and if extending the duration of the non-fixed topic to end at the start time for the fixed topic is permitted. Otherwise, if there is time available in the meeting agenda for filling out the time gap, a break is inserted between the non-fixed topic and the subsequent fixed topic. If there is not time available in the meeting agenda for filling out the gap, then the system may take a topic of another of the non-fixed topics or portion thereof, if another of the non-fixed topics may be split based on the rules. For example, the method may change the start time of a topic or sub-topic having a duration equal to or less than the duration between the end time of the non-fixed topic and the start time of the subsequent fixed topic, for example, such that the start time coincides with the end of the previous non-fixed topic. In this way the meeting agenda may be optimized for covering as many topics as possible within a set time period for a meeting agenda, for example.

If any non-fixed topics have no value for duration specified, then if there is remaining time of the meeting agenda not allocated to one or more of the topics, the method may distribute the remaining time among the non-fixed topics with no value for duration specified, for example. If there is no remaining time of the meeting agenda not allocated to one or more topics and any non-fixed topics have no value for duration specified, then if sufficient time may be taken from other non-fixed topics having a specified duration, based on the rules of the system, then the method may release from the other non-fixed topics having a duration specified the time needed to schedule non-fixed topics having no duration specified. This released time may be allocated among the non-fixed topics having no duration specified. If sufficient time is not available from only other non-fixed topics, then the system may release time from the fixed topics, if any fixed topics have time that may be released based on the rules. The time released from fixed topics may be allocated among the non-fixed topics having no duration specified, based on rules of the system, such as equally among topics, for example. Otherwise, if sufficient time is not available from the non-fixed topics and the fixed topics, then the method may provide an alert or notice that there is insufficient time for all of the topics to be scheduled. This notice informs the organizer or responsible resource that edits to the meeting agenda are necessary before completing the final meeting agenda. For example, one or more topics may need to be parked and/or the duration of topics or the meeting agenda may need to be altered.

In one example, optimizing of the meeting agenda occurs after the meeting agenda has been created or edited, and an automatically generated dashboard chart may include information relating to the meeting agenda, the plurality of tasks, conduct of a meeting using the meeting agenda and feedback obtained after conduct of the meeting. The system may provide the organizer and other users a dashboard chart display, for example. The method may comprise conducting a meeting using the meeting agenda, and capturing data on the conduct of the meeting during the meeting.

In one example, the method includes'parking a topic or sub-topic. For example, during a meeting, an organizer may select a particular topic and may have an option of parking the particular topic, such that information related to the topic is flagged as saved in a parking lot or is saved in a database flagged as a parking lot database. This allows the particular topic to be skipped, for example, due to time constraints, missing participants or lack of data necessary for discussion of the topic. Then, the system may make the topic or a sub-topic available during creation of a new meeting agenda or during editing of a different saved meeting agenda, such as by selecting the parked topic from a mind map, list, database or the like. Likewise, a topic may be saves after completion of a meeting, such that the topic and its information is flagged as a past meeting topic or is saved in a database flagged as a past meeting database, wherein the topic or portion thereof is available during creation of a new meeting agenda or during editing of a different saved meeting agenda.

The system may provide detailed analysis of data captured during meeting planning, conduct of the meeting and feedback following the meeting, together with task data and user data. For example, the system may include a rating or review of the efficiency of an organizer or responsible person, which may be used in determining compensation, such as salary and bonuses, promotions and other personnel decisions, based on reviews of efficiency and effectiveness.

Topics visualized in a mind map and/or agenda may include color schemes, icons or other types of details to show relationships between topics, for example. Each mind map contains a root and at least one main branch and optionally additional branches and/or sub-branches. These branches and/or sub-branches may be mapped as topics and/or sub-topics of a meeting agenda.

Other combinations and variations of the mind mapping system and advantages of the mind mapping system will be apparent from the drawings and detailed description.

### BRIEF DESCRIPTION OF THE DRAWINGS

FIG. 1 illustrates an example of the use of a shared workspace by multiple users.

FIG. 2 illustrates an example of a flow chart for determining what level of access a user has to the shared workspace.

FIG. 3 illustrates an example of branch locking by an organizer.

FIG. 4 illustrates an example of branch locking by a user other than the organizer, showing a locked branch.

FIG. 5 illustrates an example of a flow chart for providing read and write access privileges to documents in a shared workspace with branch locking.

FIG. 6 illustrates an example of creating a mind map and distributing tasks using a shared workspace.

FIG. 7 illustrates an example of information entry into a task management mind map for a 2^{nd} issue.

FIG. 8 illustrates an example of adding resources to a particular Branch ID for the 2^{nd} issue of FIG. 7.

FIG. 9 illustrates an example of the interface for actuating distribution of the tasks from the shared workspace.

FIG. 10 illustrates an example of an email notification to a resource listed in the examples of FIGS. 7-9.

FIG. 11 illustrates an example of the tasks tab accessed by a resource in shared workspace, listing tasks assigned to the resource.

FIG. 12 illustrates an example of an interface to import tasks from resources.

FIG. 13 illustrates another example of a flow chart for distributing tasks using Microsoft Outlook®³, for example. ³ Microsoft Outlook is a registered trademark of Microsoft Corporation.

FIG. 14 illustrates an example of an interface for exporting and synchronizing tasks in Outlook®.

FIG. 15 illustrates an example of check boxes for including or excluding certain information from being exported to Outlook®.

FIG. 16 illustrates an interface for synchronizing the mind mapping system and Outlook®.

FIGS. 17 A-B show an example of A) a mind map and B) a meeting agenda generated from the mind map.

FIG. 18 illustrates an example of a tool for specifying rules for rounding and splitting of topics.

FIG. 19 illustrates an example of a break distribution tool for specifying rules for breaks.

FIG. 20 illustrates another example of a screen shot during adjusting of a meeting agenda including scheduling tool for specifying the start and end of the meeting agenda, number and duration of breaks, and start times and end times of breaks, such as breakfast, lunch and dinner.

FIG. 21 illustrates an example of a template tool for formatting an agenda.

FIG. 22 illustrates an example of a screen shot showing an agenda wizard tool for adjusting the number of topics and breaks during a meeting agenda.

FIG. 23

FIG. 27 illustrates an example of a flow chart for a time distributor system for automatically creating and editing a meeting agenda including examples of a flow diagram including a time distributor and topic adjusting systems.

FIG. 28 illustrates an example of a flow chart for the time distribution system, showing an example for rules that distribute time on non-fixed topics, and if there are non-fixed topics without duration specified and no remaining time exists in the meeting agenda, then time is collected from topics with specified durations and is distributed to topics without specified durations, for example.

FIG. 29 illustrates an example of a topic adjusting system allowing adjusting of a meeting agenda based on rules, such as fixed topics are sequenced in order from first start time to last start time, no topics are allowed to overlap and no gaps are allowed between topics and meeting start time, for example.

FIG. 30 illustrates an example of data storage and display for a meeting dashboard capable of organizing and displaying statistical data relevant to the system and method of collaboration and meeting management, for example.

FIG. 31 illustrates an example of parking and saving topics for later use in generating a later meeting agenda, for example.

### DETAILED DESCRIPTION OF THE DRAWINGS

The drawings and detailed description show examples and should not be used to limit the claims that issue.

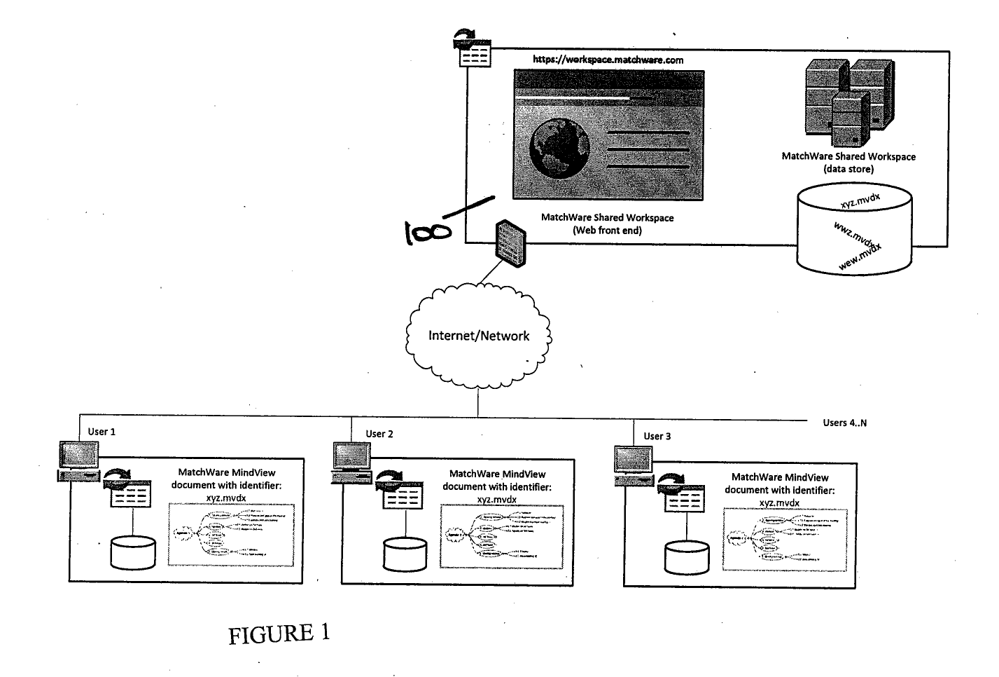

In FIG. 1, shows a plurality of users accessing a shared workspace over the internet or a computer network. Each of the users accesses the shared workspace using a computer system or work station that is electronically coupled by a network to one or more servers hosting the shared workspace. The shared workspace is stored in one or more databases stored on one or more storage media accessible by the users through the shared workspace. In one example, the shared workspace comprises a set of internet-based services designed for customers and/or businesses interested in storing and sharing documents, accessible online by multiple users. In one example, one of the known services providers are used host the shared workspace. Any document located in the shared workspace is able to be shared among a plurality of users. In one example, a mind mapping document is shared between users, which can be shared for real time collaboration, the mind mapping document being shared by a plurality of users, simultaneously, in a collaborative editing of the mind mapping document, for example. A shared workspace is used as a platform for hosting a collaborative mind map, as part of a mind mapping system comprising at least one server, at least one storage medium coupled to the server, and a plurality of users coupled to the at least one server over a network, such as the Internet or an intranet. The entries or edits made by the plurality of the users are immediately distributed via the shared workspace to every other user accessing the same document, synchronizing the document in real time.

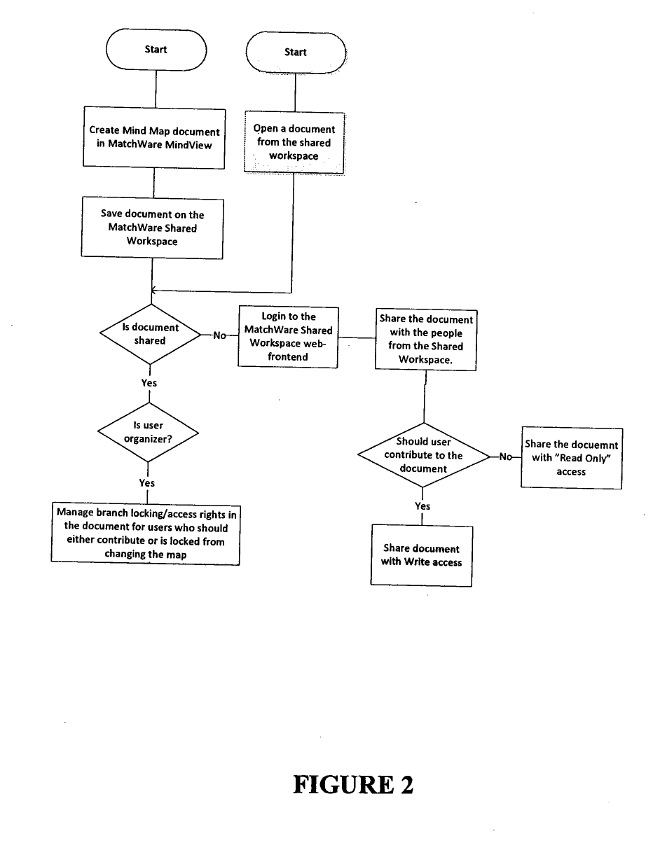

Documents, such as a mind map documents, that are shared in the shared workspace 100 may be set up by an organizer for viewing (read only access) or for editing (read/write access) by one or more individuals. In one example, the mind mapping system provides limited write access to one or more resources, i.e. individuals designated by the organizer as resources in a resource list associated with a mind map, by locking certain branches to editing by any of the one or more resources. For example, a resource may be granted permissions to access certain branches or may be denied access to certain branches, using a unique Branch ID or using a graphical interface. In one example, the default setting is for every resource listed in a resource listing by an organizer to have open access, i.e. write access, to edit an entire mind map document, and the organizer must specify if certain branches within a mind map are to be locked. FIG. 2 illustrates a flow chart showing how the type of access to a mind map is determined during access to a mind map. If the user accessing the document is the organizer, then complete access is granted including the ability to manage branch locking and access rights to locked branches. Users other than the organizer may or may not have access to all of the branches of a mind map document. A user may be denied access to a document if the user does not have a valid user identification and password, for example. If the user successfully logs into the shared workspace, then the mind map system determines if the user is granted read-only or write access within the document.

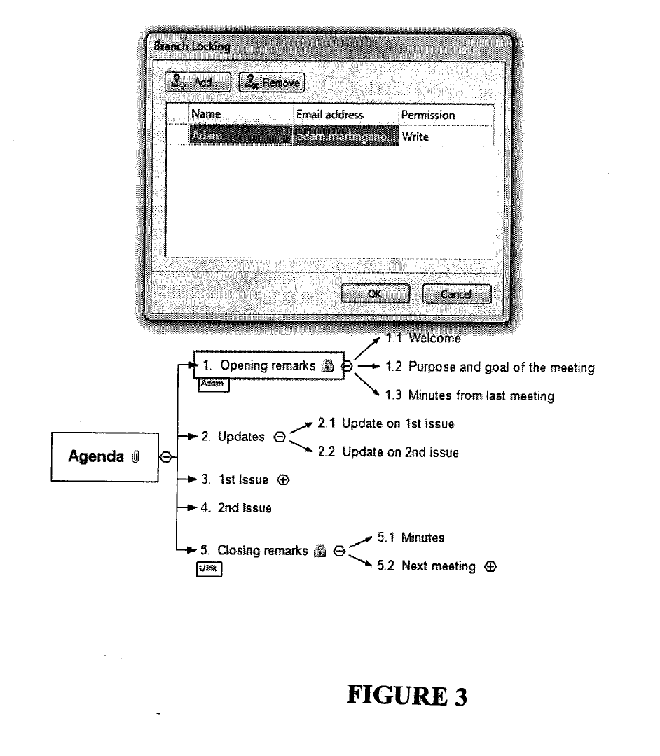

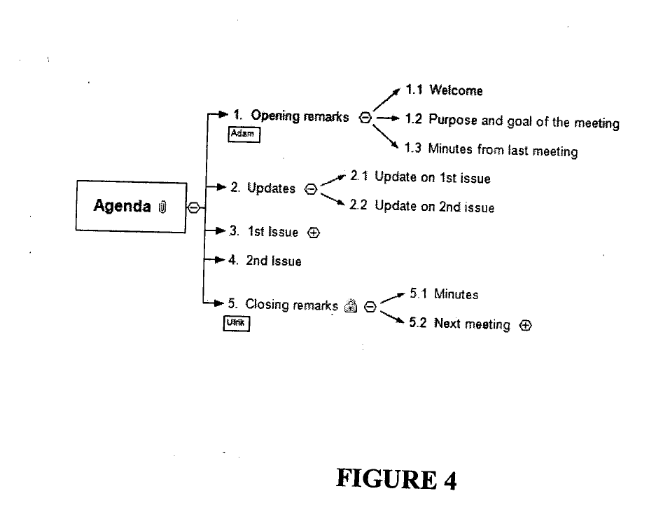

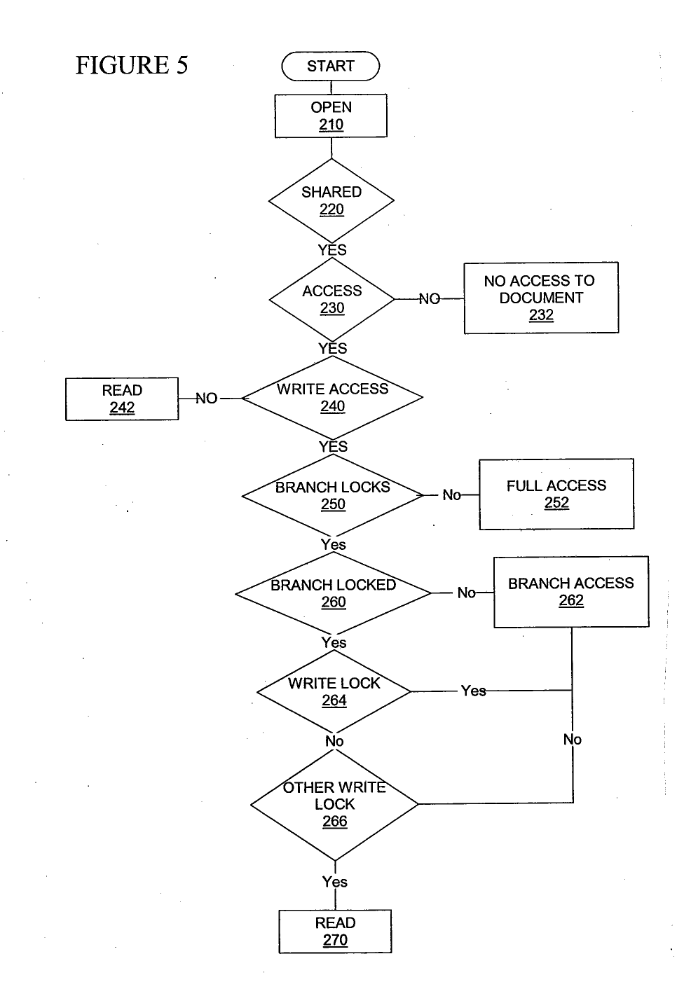

FIG. 3 illustrates an example of a document and interface for use by an organizer where branch locking is used. In this example, an agenda with branches is provided for a collaborative meeting in a shared mind map workspace. The opening remarks and the closing remarks are locked by the organizer, but access is permitted to one or more users to locked branches, such as Adam and Ulrik, in the example of FIG. 3. FIG. 4 illustrates an example of the interface as viewed by one user, Adam, which shows a lock on the closing remarks branch of the mind map document. In this example, the lock is a read-only lock that prevents Adam from editing anything in the closing remarks branch of the mind map. Alternatively, a write lock may be provided on a branch that permits only a designated user or users of the shared workspace the right to write and edit within a particular branch of a mind map within the mind mapping system. A flow chart is shown in FIG. 5. In this example, a shared mind map is opened 210 and the mind mapping system determines if the document is a shared document 220. If so, then the system determines if the user is permitted to share the document 230, and if so, then the system determines if the user has write permissions 240 in the document. Denial of access 232 or read-only access 242 may be granted by the system. If write permissions are granted, then the system continues to determine access to branches within the mind map document 250. If not branches are locked, then full read/write access is granted 252 to the user. Otherwise, access to certain branches is controlled 260 for each Branch ID, including child branches of a parent Branch ID. Unlocked branches may be fully accessed 262 by permitted users. Otherwise, the system checks to see if the particular user has a write lock 264, giving the user full access 262, or if another user does not have a write lock, then full access may be permitted 266. Otherwise, read only access is permitted 270 to the particular branch.

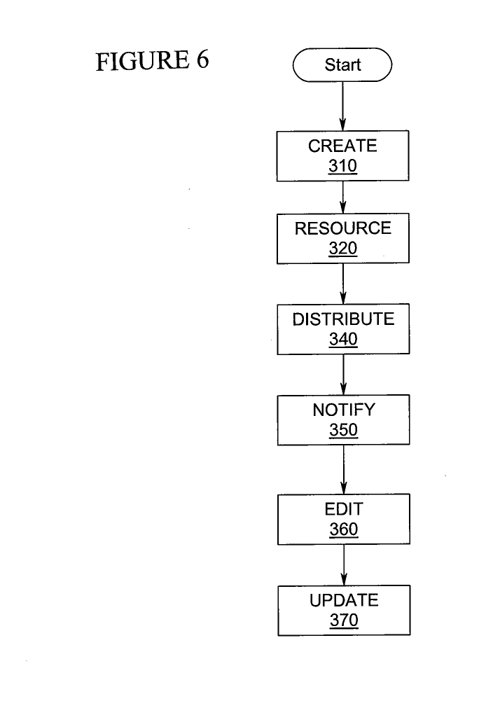

In another example, which may be combined with the previous examples, the system may provide access to distributed users at particular times or within particular time windows. For example, in FIG. 6, an organizer creates a mind map within the mind mapping system 310 and attaches information to one or more branches within the mind map 320. Resources may be added to one or more branches 330 by the organizer by entering the name and/or email addresses of the particular resources, granting access to the branch by the resources, with or without branch locking. The information may include a start time and an end time, and/or duration, which can automatically trigger an event, or the organizer may manually begin an event, which distributes 340 the task information in a branch to a shared workspace. For example, email notification 350 may be made to notify resources listed by the organizer in association with a Branch ID of the task. The task may be accessed in the shared workspace or information about the task may be exported to an external task scheduler or project management system, for example. In FIG. 6, the resource modifies the information in the branch directly in the shared workspace 360. The system can be updated automatically by a scheduled event or manually by the organizer, updating the organizer's mind map 370, based on input made by resources in the shared workspace, for example.

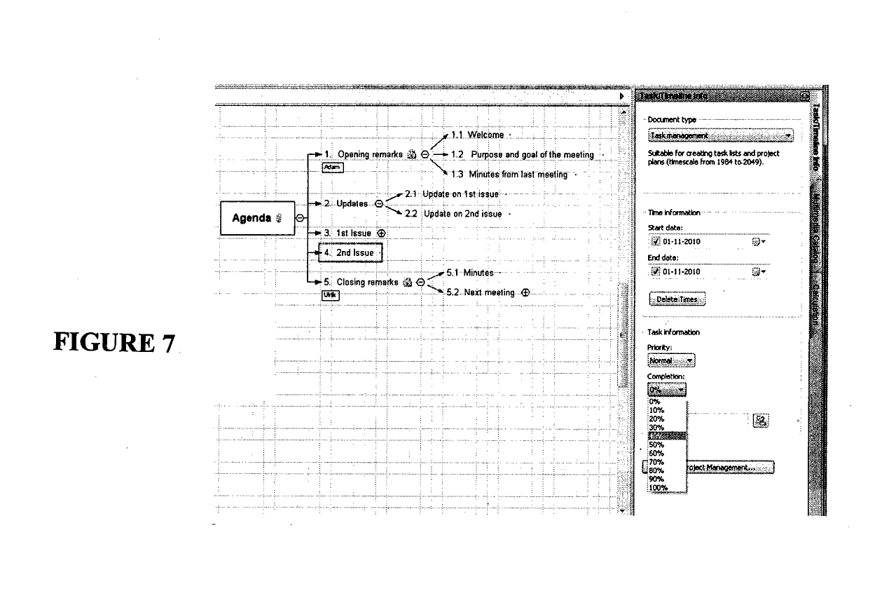

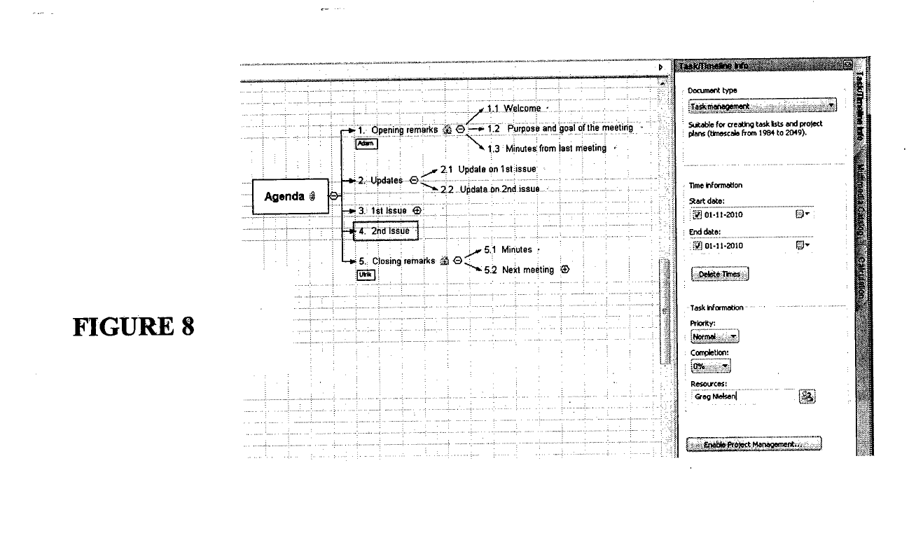

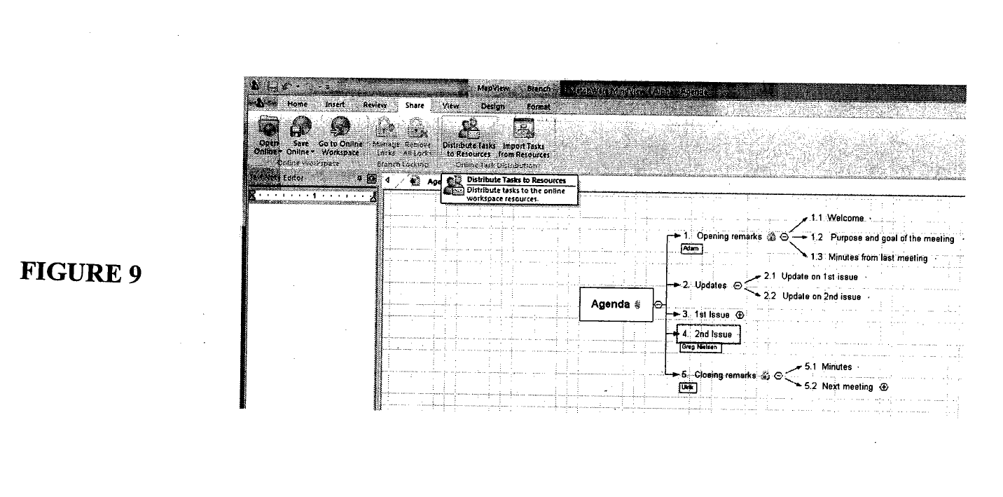

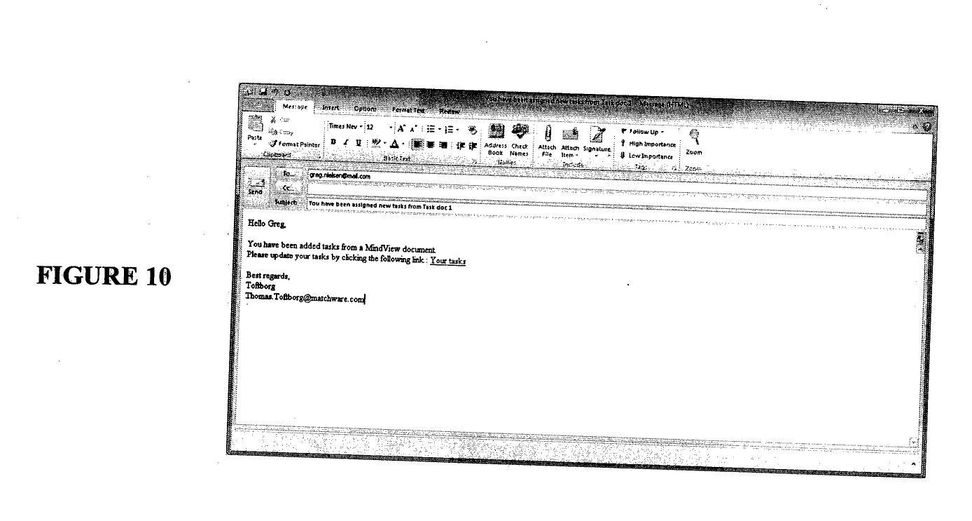

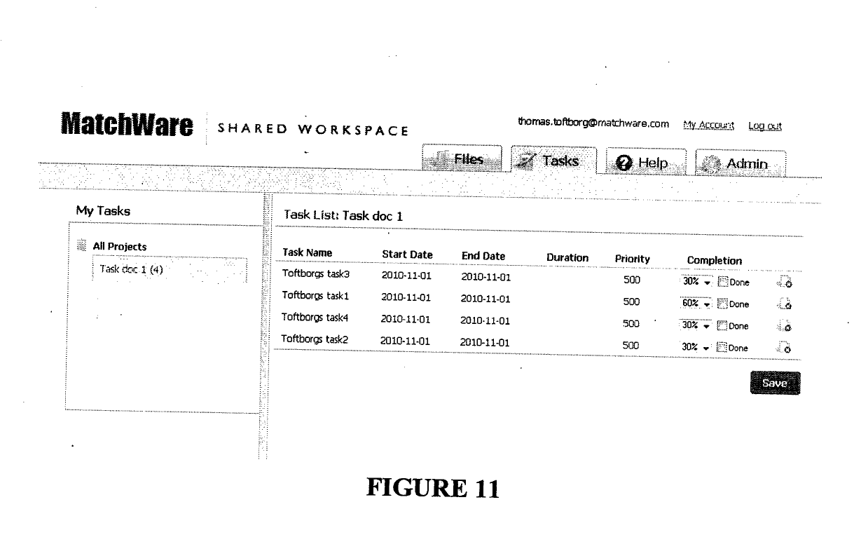

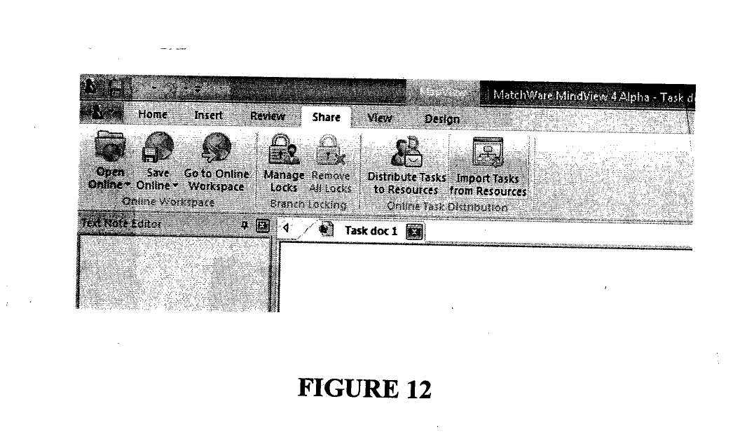

FIGS. 7 illustrates an example of an agenda mind map with a series of issues to be addressed in the mind map. An interface is provided for showing and editing information in each of the issues, with this example showing a 2^{nd} issue, which is being modified to show that it is 40% complete. In the example of FIG. 8, the 2^{nd} issue is shown as 0% complete, and the organizer is assigning Greg Nielsen as a resource, which is represented in FIG. 9 as a box associated with the branch designated as the 2^{nd} issue in the agenda mind map. In FIG. 9, the organizer is manually triggering a distribution of the 2^{nd} issue task to the resource, Greg Nielsen. FIG. 10 shows an email notification sent to Greg Nielsen, providing a hyperlink from the email to the agenda mind map in the shared workspace. FIG. 10 shows one example of a task list interface provided for tracking tasks for a plurality of projects within the shared workspace. In FIG. 11, the organizer is provided with an interface to import updated information from the shared workspace, which may be updated by resources, to the organizer's mind map document Task doc 1.

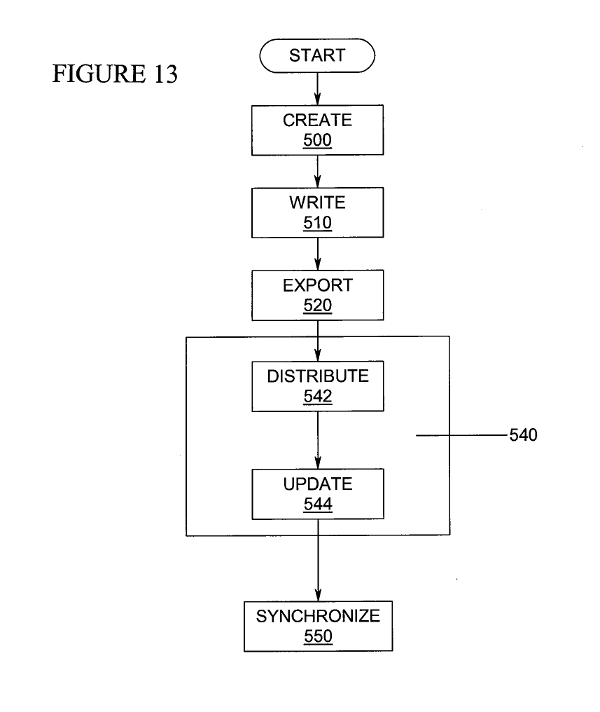

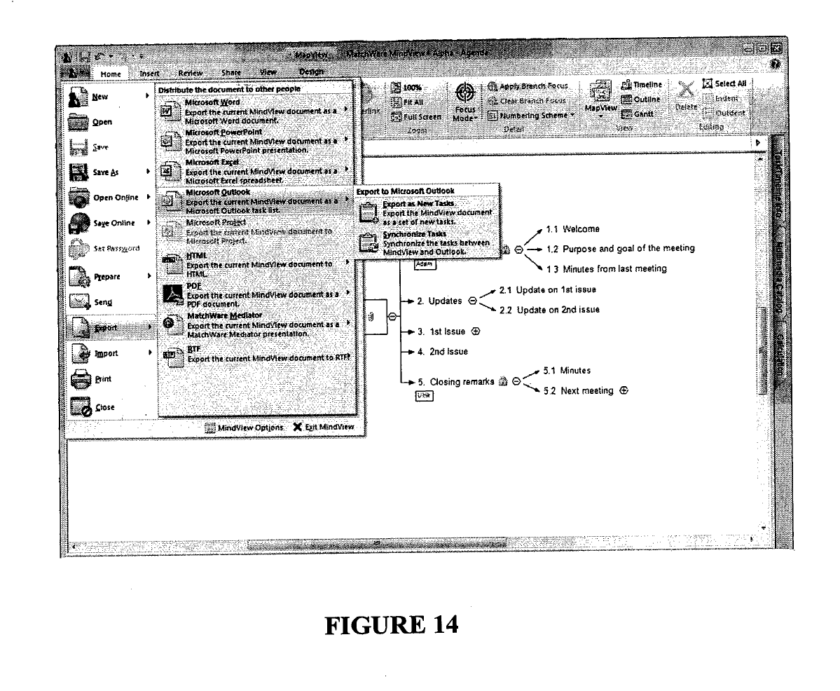

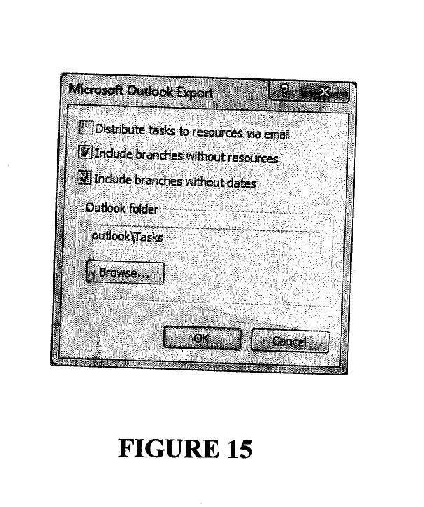

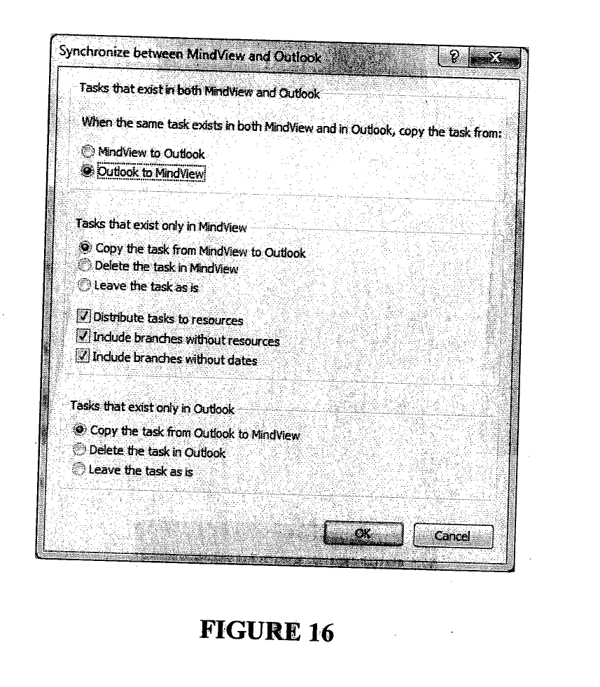

In FIGS. 13-16, an interface is provided for communicating with resources using an external task scheduling software, such as Microsoft Outlook®. In this example, a mind map is created 500 and information is associated with one or more branches 510 by the organizer of the mind map within the mind map system, which may include a plurality of resources associated with one or more branches, for example. The organizer exports 520 tasks to the resources using the export system to an external task tracking system 540, which is external to the mind mapping system. The organizer's external task tracking system 540 automatically distributes the tasks to one or more resources 542 listed in the mind map, which are associated with particular Branch ID's. Information in the tasks are updated by the resources and automatically update the organizer's and other resources external task tracking system 544. The organizer is capable of updated the mind map in a synchronization 550 process that updates the mind map of the organizer based on the updated information in the organizer's external task tracking system 540, such as Outlook. For example, the task title, comments, start time, end time, priority, percentage complete and recipients may be input and/or updated by the organizer in the mind map, which may distribute, automatically, such information to resources listed by the organizer upon export of the mind map to the organizer's Outlook task schedule. For example, FIG. 14 shows an interface for exporting and synchronizing information between the mind mapping system and an external task tracking system. The interface in FIG. 15 allows the organizer to specify whether to distribute tasks to resources via email, to include branches without resources and to include branches without dates in the exporting of a mind map to a shared workspace and/or to an external task tracking system. FIG. 16 illustrates a synchronization interface that allows the organizer to select certain parameters during synchronization, for example. The direction of the synchronization may be specified, and includes an interface for tasks that exist only in the mind mapping system. Such tasks may be copied from the mind mapping system to the external task tracking system, for example, or may be deleted from the mind mapping system. A plurality of options may be provided for distributing updated information to resources, for including branches without resources and for including branches without dates, for example. In addition, for tasks that exist only in Outlook, the organizer may opt to copy the tasks from Outlook to the mind mapping system, to delete the tasks from Outlook or to leave the tasks unchanged. Thus, the interface may be highly configurable and flexible, providing a number of options for controlling the export and import of information between the organizer's mind map and an external task scheduling system, outside of the organizer's mind map, such as Outlook or another popular project management or task scheduling solution.

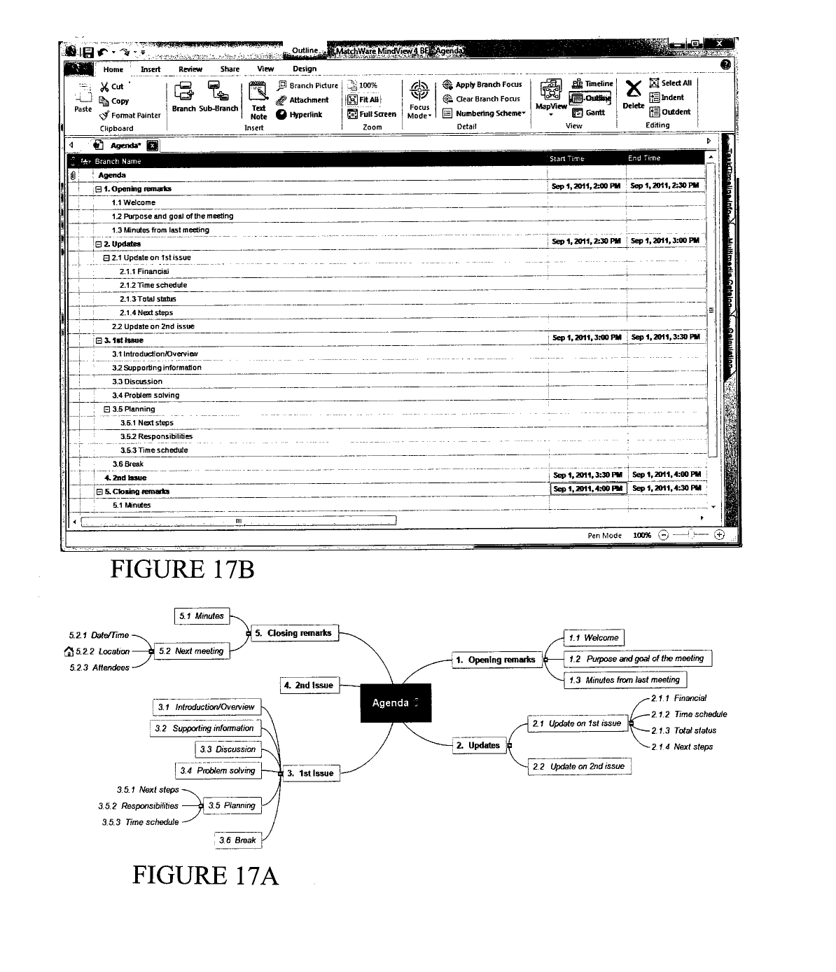

When creating an agenda electronically, whether online or offline, an agenda may be created as an outline as illustrated in FIG. 17B, for example, or a mind map as illustrated in FIG. 17A, for example. In an outline, each main topic will have its own line and sub topics may be illustrated by a simple indention or by a numbering schema. In a mind map the main topic may be a main branch extending from a root and the sup topic may be a sub branch, and so forth, for sub sub branches and the like. Whether the agenda is created as an outline or a mind map, the system is capable of displaying one as the other and exporting either to an external report in any of the known document formats.

For example, a topic is defined as an agenda item where the meeting system will be able track information such as notes, comments, time spent, time remaining, duration assigned and the like. A topic can be classified as a break, which indicates that a break is planned in the meeting, for example, or a break may be input using a tool. Such a topic may be referred to as a topic-break. For example, if a topic contains a duration but no start and end time, it may be referred to as a non-fixed topic. A topic with a specific start and end time an/or duration may be referred to as a fixed topic. In the case when a topic doesn't contain either it is referred to as a planned topic or a non-fixed topic without a specified duration. A valid agenda is defined as a list of topics, where the sum of the topics duration is less than or equal to the time span (i.e. duration between the start time and end time) of a meeting agenda. Each topic in a valid agenda starts when the previous topic in the list ends, for example. A first topic in the list may start at the meeting start time, for example.

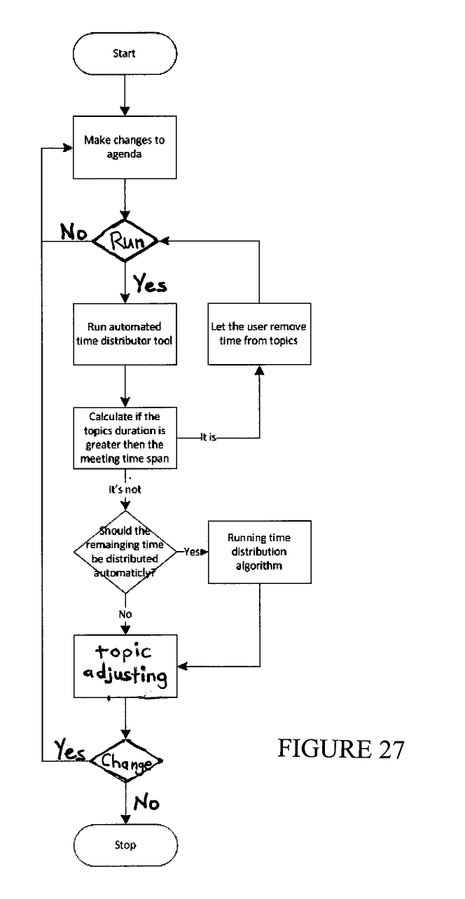

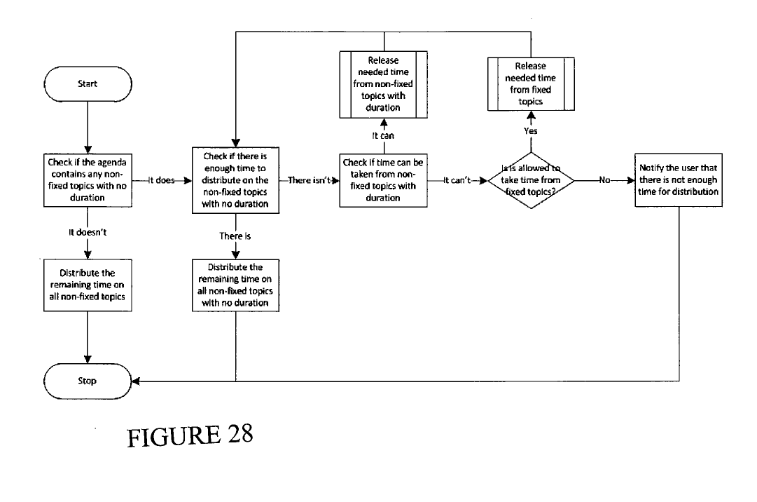

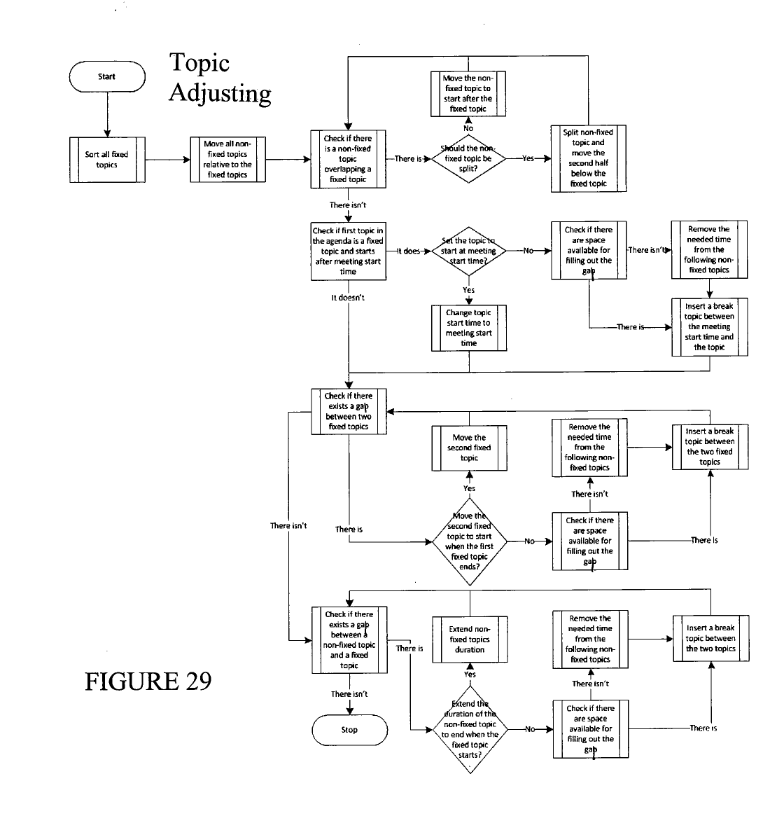

As shown in FIG. 27, for example, a tool may take a list of topics defined as above and may display run a time distributor tool and a topic adjusting tool, for example. The topic adjusting tool may be considered an agenda error correction tool, for example. If the sum of the topic durations exceeds the meeting time span, a user may be asked to remove time or topics from an agenda and the flow chart may terminate when all of the changes to the agenda are made. If the list contains any planned topics, the tool can automatically distribute remaining time on the planned topics so they become non-fixed topics with durations or it can ignore them and consider them as non-fixed topics with a duration of 0 (or no specified duration), for example. In the case where it distributes the remaining time on the planned topics, it may follow the flow chart of FIG. 28, for example. First, a check may be made to see if there is enough time remaining on the meeting to distribute to the planned topics. If not the system may take time from the non-fixed topics, and if that is not enough it may take time from fixed topics with the users permission or based on rules specified in the system. For example, where rules do not allow the tool to take time from fixed topics, it may notify the user that there is not enough available time and may terminate the system or return to a tool for the user to make changes to the agenda. A tool may be provided to prevent distributing only a brief duration, such as a minute or a few minutes on each planned topic. The system may have a setting for a rule to define a minimum duration for any topic. Once all topics have a duration, the topics may be rearranged and modified by the tool, as illustrated in FIG. 29, for example. The topic adjusting tool may locate each of the following errors in the agenda and fix the, for example

The first agenda topic is a non-fixed topic and starts after the meeting start time. The first agenda topic is a non-fixed topic and starts before the meeting start time. The first agenda topic is a fixed topic and start after the meeting start time. The first agenda topic is a fixed topic and start before the meeting start time. The agenda contains a gap between two fixed topics. The end time of a fixed topic overlaps the start time of a fixed topic. The agenda contains a gap between two non-fixed topics. The end time of a non-fixed topic overlaps the start time of a non-fixed topic. The agenda contains a gap between a non-fixed topic and a fixed topic. The end time of a non-fixed topic overlaps the start time of a fixed topic. The agenda contains a gap between a fixed topic and a non-fixed topic. The end time of a fixed topic overlaps the start time of a non-fixed topic. The start time of a non-fixed topic (A) begins after the start time of a non-fixed topic (B), and A is followed by B in the list. The topic before A in the list has an end time T, if there is no such topic then T is the start time of the meeting. The start time of a fixed topic (A) begins after the start time of a fixed topic (B), and A is followed by B in the list. The start time of a non-fixed topic (A) begins after the start time of a fixed topic (B), and A is followed by B in the list. The start time of a fixed topic (A) begins after the start time of a non-fixed topic (B), and A is followed by B in the list.

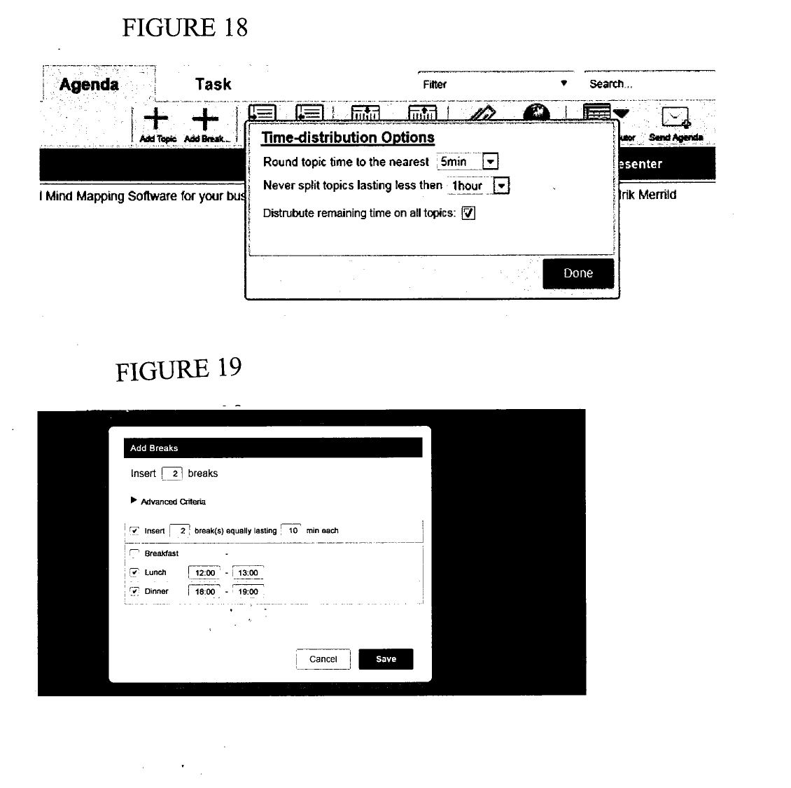

If the user prefers that all topics are not uneven or uncommon such as: from 2:31 to 2:49 pm etc., it is possible for the user to set a rounding tool as shown in FIG. 18, for example, to round all topics start and end time to the nearest specified number of minutes. The tool then does the rounding for all the start and end times before the system starts to fix the topic adjusting in the agenda, as illustrated in FIG. 29, for example.

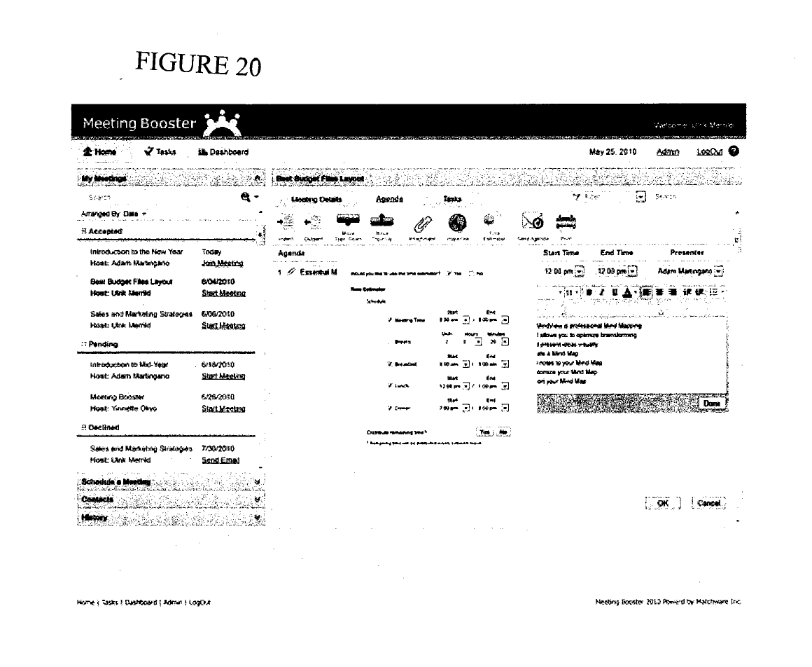

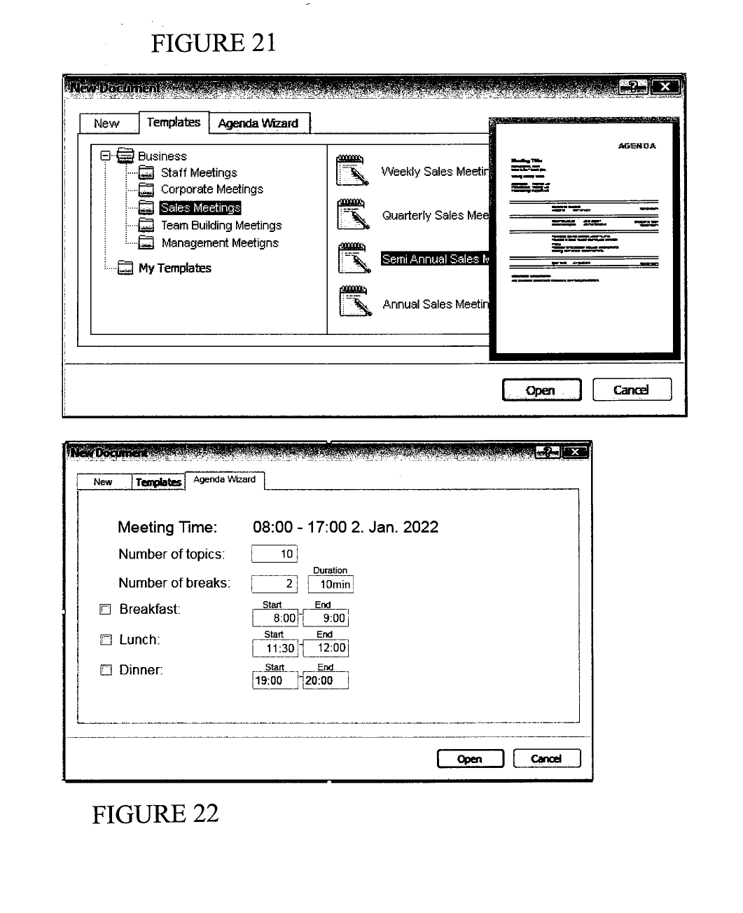

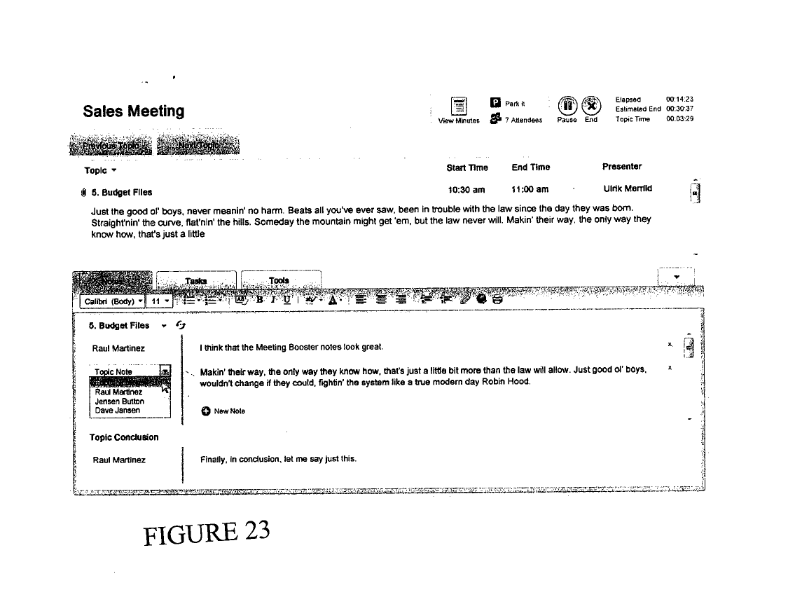

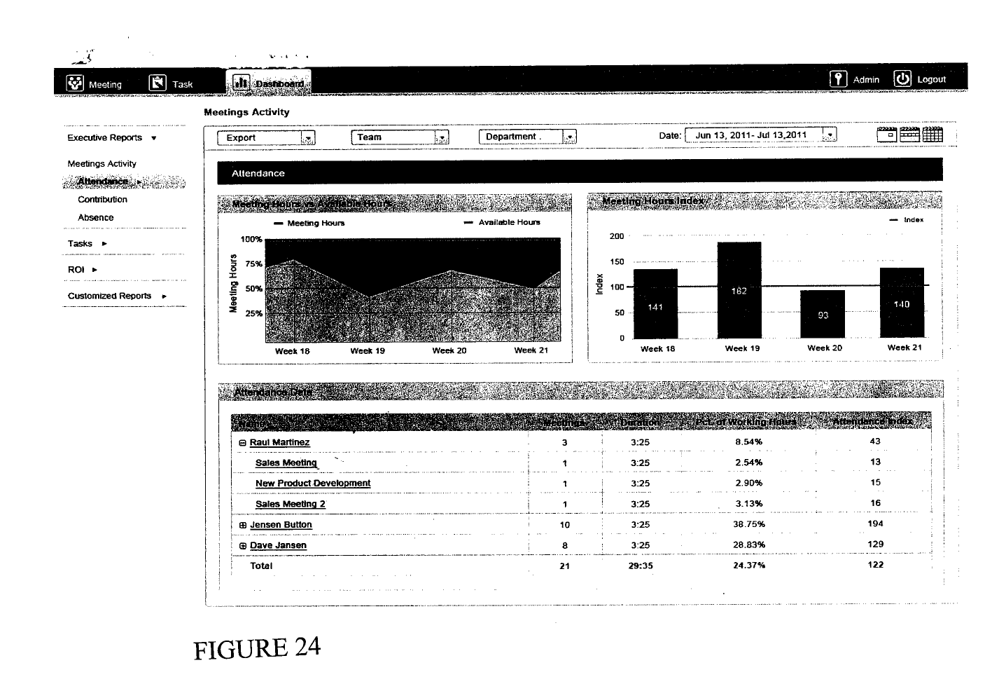

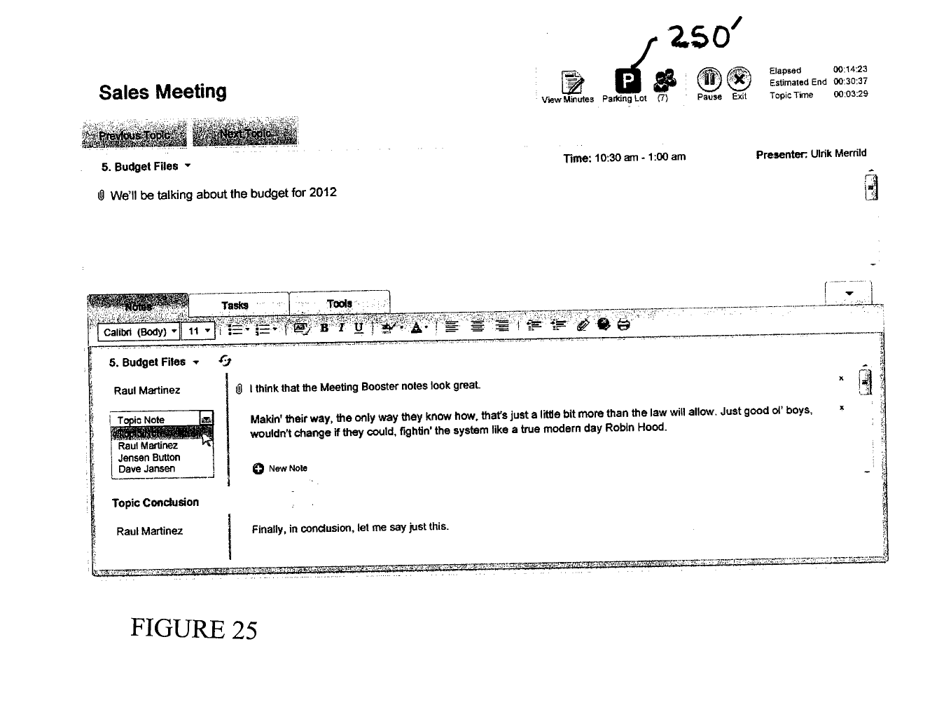

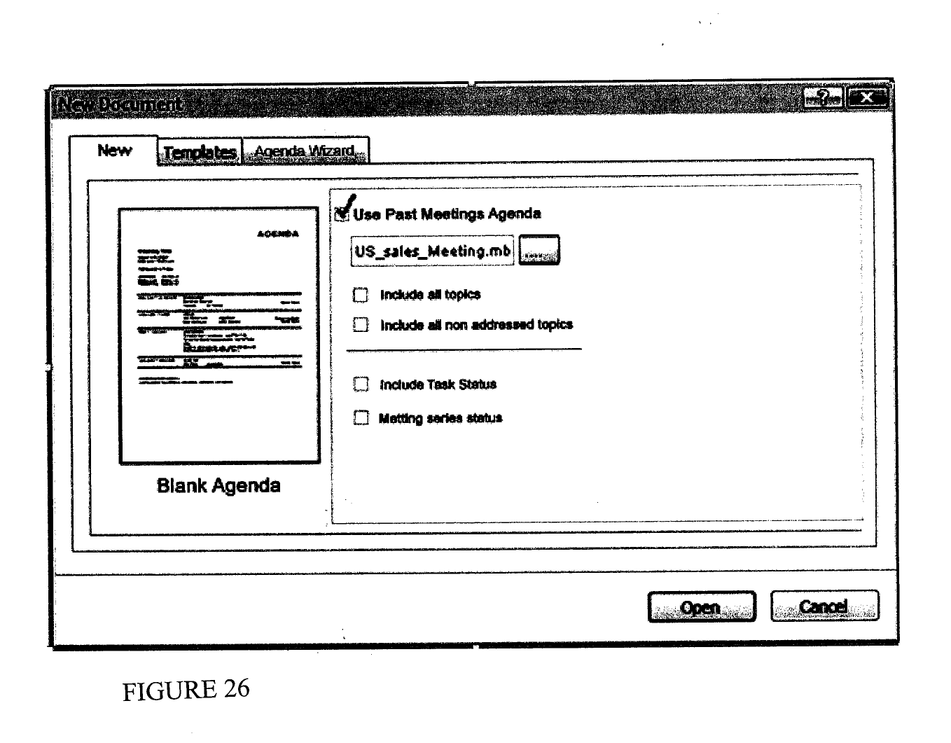

Breaks may either be inserted in the agenda before activating the time distribution feature as illustrated in FIG. 19 or may be included in the dialog for the time distribution feature illustrated in the example of FIG. 20, for example. Further, breaks can be inserted during the use of the agenda wizard, as illustrated in the example of FIG. 22, where a template is selected with pre-made topics first and then breaks are added as the second step.

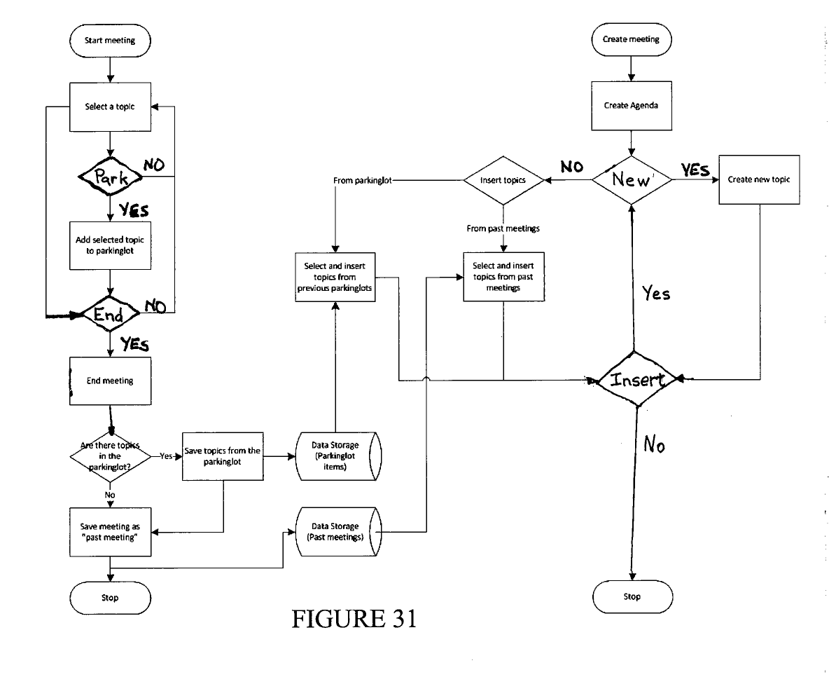

The use of a parking lot, allows users to park certain topics in an agenda that they may want to cover later or in a future meeting. Topics can for instance be postponed when running the meeting by clicking a button; and this button in meeting terms, is often referred to as the Parking Lot 250 as illustrated in FIG. 25, for example. Alternatively, the meeting management system can automatically detect if the topic was postponed or skipped, by running a set of rules such as; no time spent on this topic, or no notes made for the topic. When the meeting has ended all the parked topics are stored as shown in FIG. 31, for example. Also all the topics on the meeting are stored no matter if they are parked or not.

In turn, the postponed topics could be accessible when making the new agenda, where a user could get an overview of postponed topics, filter them by options such as by meetings, and then drop such topics directly into the new agenda outline. Previous agendas could be looked up as well when making a new agenda and the user could be allowed to pick and choose topics from previous agendas, and include them in the new agenda. Subject based templates will also be made available for selection through the use of a wizard, which will allow users to select a premade template as a new agenda as illustrated in the example screen shot of FIG. 26, for example.

Users may have the ability to collect meeting specific data from any number of meetings to be used in Dashboard style reports covering things like detailed meeting costs, high and low performing hosts or attendees, accountability relating to task completion, meeting performance based on if meetings are kept according to schedule relating to start and end times as well as the scheduled date of the meeting, for example.

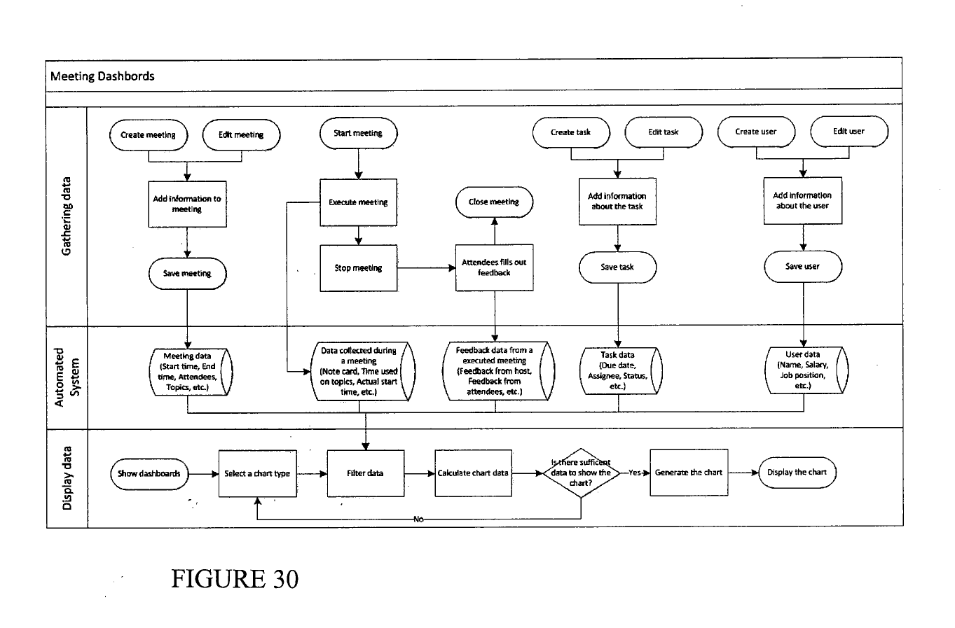

Via wizards, filters and custom settings, users can access meeting specific data from any number of meetings and can run Dashboard style reporting on such data to provide statistical information to be used for optimizing and streamline the meeting process, as illustrated in the flow chart example of FIG. 30, for example. Before the meeting starts, organizers can check mark which participants are present so the meeting management system can compare this to who accepted the meeting invitation. When executing a meeting an electronic note card can be used to take notes for each topic, including but not limited to; text notes, voting notes, ink drawing notes, pros and cons graphs, and so forth. The notes are later converted by the meeting management system into a meeting minutes report.

The invention also extends the note card so it captures notes made by individuals or as a group, per topic or for the meeting in general. The invention will further document what time such notes were made and who made them, the total time spend on topics, will allow for task allocation for each topic or for the meeting in general, voting results, mind maps, ink drawings, and so forth, as illustrated in the screen shot example of FIG. 25. The meeting management system will track if a topic is discussed within the time allocated, if the meeting is running late, starts late and so forth. The meeting management system also tracks if tasks are done on time and will be able to send reminders to users pertaining to such tasks. Users can have their individual “V-Card” where their location and status within the organization are listed as well as their salary. The system will be able to send out meeting feedback surveys, and such surveys could range from very basic to customizable 360 multi rating reports. This feedback can be anonymous or stated as a defined user. The invention is to create meeting performance data based on the combination of the captured notes from the note card, the tracking system and other information captured by the meeting management system. Key Performance Indicators such as Meeting Costs, Meeting Activity, Contribution, Absence, Best Host, Best Attendee, Best Meeting, Gap Analysis, Opportunities Report, Meeting evaluation reports and more will be created by the meeting management system. Users will be able to run correlations on key parameters to explain differences for KPIs (Key performance Indicators).

The computerized meeting management system may be integrated with other systems and could for instance export Meeting Appraisal information to Human Resources Management Systems, as illustrated in the example of a Meeting Performance Dashboard in FIG. 24.

What is claimed is:

1. A system for collaboration and meeting management comprises:
a computer system including a processor, a memory storage device, a database structure, an input device and an output device, operatively coupled together;
the processor of the computer system is capable of receiving instructions stored in the memory storage device of the computer system, such that the computer system implements a mind mapping system wherein each branch of a mind map created by a user is assigned a unique identifier by the mind mapping system, and each child branch extending from each branch is assigned a unique child identifier, such that the unique child identifier includes a reference to the unique identifier of the branch from which the child branch extends, and
the input device is coupled with the processor such that the mind mapping system is capable of allowing an organizer of a project to control the mind mapping system, such that the mind mapping system is capable of converting each unique identifier into a task of the project, and the mind mapping system is coupled with the memory storage device such that a plurality of parameters are arranged in the database structure, the plurality of parameters including a value for task scheduling and a value for task distribution to at least one allocated resource;
the output device is coupled with the processor such that the mind mapping system is capable of visually displaying a branched, hypertextual mind map on the output device to the at least one allocated resource, and the value for task distribution determines whether the at least one allocated resource has permission to change any of the plurality of parameters arranged in the database structure; and
the mind mapping system includes a shared workspace for collaborative mind mapping of each of the tasks and an external export system for exporting each of the tasks to an external project management or task tracking system of the at least one allocated resource, according to the value for task distribution and data contained in the value for scheduling.

2. The system of claim 1, wherein the value for task scheduling in the database structure includes a value for duration and a value for start date.

3. The system of claim 1, wherein the at least one allocated resource has access to the output device for visually displaying a branched, hypertextual mind map including only those branches to which the value for task distribution provides.

4. The system of claim 1, wherein the external export system of the mind mapping system includes an input system for receipt of changes from the external project management or task tracking system of the at least one allocated resource.

5. The system of claim 4, wherein the input system is capable of receiving changes to the value for scheduling including duration, start date, end date, priority, completion, resources, and combinations thereof and updating the value for scheduling in the memory storage device of the computer system.

6. The system of claim 5, wherein the external export system is arranged to automatically update the external project management or task tracking system of each of the at least one allocated resource and the organizer, according to the value for task distribution, when the input system updates the memory storage device of the computer system.

7. The system of claim 5, wherein the input system is arranged to reject changes to the value for scheduling automatically when the value for task distribution includes a parameter for locking the unique identifier or the unique child identifier to prevent changes to the value for scheduling related to the unique identifier or the unique child identifier.

8. The system of claim 7, wherein the input system is coupled with the external export system such that the input system automatically exports feedback to the external project management or task tracking system via the external export system when the input system automatically rejects changes to the value for scheduling.

9. The system of claim 7, wherein the, external export system is arranged to automatically return the value for task scheduling in the external project management or task tracking system to a previous value, when the input system automatically rejects changes to the value for scheduling.

10. The system of claim 7, wherein the input system is coupled with the external export system such that the input system automatically notifies the organizer, when the input system automatically rejects changes to the value for scheduling.

11. The system of claim 1, wherein the external export system automatically pushes the value for task scheduling to each of the external project management or task tracking systems of the at least one allocated resource, according to the value for task distribution, from time to time on a schedule, even if the value for task scheduling has not been updated by any of the at least one resources.

12. A method for collaboration and meeting management using the system of claim 1 comprises:
implementing a mind mapping method comprising creating a visual mind map of a plurality of branches of a mind map generated in the mind mapping system of claim 1;
assigning a unique identifier for each branch of the plurality of branches;
extending one or more child branches from each branch in the visual mind map, and assigning a unique child identifier to each of the one or more child branches, such that the unique child identifier includes a reference to the unique identifier of the branch from which the child branch is extending;
allowing input from an organizer of a project to control the mind mapping system, such that the mind mapping method converts each unique identifier into a task of the project, and storing a plurality of parameters in a database such that the plurality of parameters include a value for task scheduling and a value for task distribution to at least one allocated resource;
visually displaying a branched, hypertextual mind map on an output device, and permitting the at least one allocated resource to change one of the plurality of parameters arranged in the database structure based on the value for task distribution;
providing a shared workspace for collaborative mind mapping of each of the tasks; and
exporting each of the tasks to an external project management or task tracking system of the at least one allocated resource, according to the value for task distribution and data contained in the value for scheduling, such that the data is received by the external project management or task tracking system in a format compatible with the external project management or task tracking system.

13. The method of claim 12, further comprising receiving changes from the external project management or task tracking system of the at least one allocated resource, when changes are made in the external project management or task tracking system by any of the at least one resource within the external project management or task tracking structure.

14. The method of claim 13, farther comprising processing the changes received in the step of receiving by checking the value for task distribution and determining if the value for task distribution permits the at least one allocated resource to make the changes received in the step of receiving changes.

15. The method of claim 14, wherein the step of processing the changes includes preventing the change and informing the at least one resource that the value is locked, when the at least one resource is not permitted to make changes to the value or values according to the value for distribution.

16. The method of claim 14, further comprising returning the value or values changed in the external project management or task tracking system back to the unchanged value or values, when the at least one resource is not permitted to make the changes to the value or values according to the value for distribution.

17. The method of claim 14, further comprising notifying the organizer of an attempt to change parameters, if the value for task distribution permits the at least one allocated resource to make the changes received in the step of receiving changes.

18. The method of claim 17, wherein the step of notifying includes describing the nature of the change to the parameters that was attempted by that at least one resource.

19. The method of claim 12, further comprising permitting particular ones of the at least one resources to make changes to particular ones of the plurality of parameters.

20. The method of claim 19, wherein the step of permitting particular ones allows different changes by the at least one allocated resource in the shared workspace for collaborative mind mapping than in the external project management or task tracking system.

21. The method of claim 12, further comprising receiving an email from the external project management or task tracking system, when the at least one resource makes a change in one or more of the plurality of parameters within the external export system.

22. The method of claim 21, further comprising determining if the at least one resource is permitted to make a particular change to a particular one of the values for scheduling.

23. The method of claim 22, wherein the step of determining includes automatically checking the particular one of the values for scheduling to determine if the change affects only one task identified by a unique identifier or will affect other tasks.

24. The method of claim 23, wherein the step of determining determines if the at least one resource has permission to change the other tasks, when the change will affect other tasks, and permitting the change to the value for scheduling only when the step of determining determines that the at least one resource has permission to change both the value of scheduling for the task identified by the unique identifier or unique child identifier and the value of scheduling for any other tasks.

25. The method of claim 24, further comprising a step of rejecting the change when the step of determining values determines that the change will affect other tasks and the at least one resource is not permitted by the mind mapping system to make changes to tasks in one or more of the other tasks.

26. The method of claim 24, wherein the step of determining rejects the change if the change would alter, necessarily, a secondary value in a branch associated with a unique identifier or unique child identifier to which the at least one resource making the change is not granted permissions to change the secondary value.

27. The method of claim 24, wherein the step of determining updates a value relating to task completion by the at least one resource authorized in the system to update the value related to task completion and automatically updates a start time for a task depending on the value relating to task completion.

28. The method of claim 12, further comprising a method of meeting management, and the method of meeting management comprises:
creating a meeting agenda in the mind mapping system by implementing a mind mapping method for generating a plurality of topics as branches in the mind mapping system, and assigning the unique identifier to the branches and the unique child identifier to sub-topics within each of the plurality of topics, if any, and saving the meeting agenda in the database.

29. The method of claim 28, wherein the step of creating provides for inputting of a title, a start time and a duration for each of the plurality of topics, such that if the title, the start time and the duration are input for any of the plurality of topics, the value for task scheduling for the particular one of the plurality of topics includes any of the title, the start time and the duration for each of the plurality of topics input in the step of creating.

30. The method of claim 29, further comprising amending the title, the start time or the duration for any of the plurality of topics, including adding or changing information related to any sub-topics within each of the plurality of topics.

31. The method of claim 30, further comprising distributing topics within an agenda based on rules within a system for distributing topics.

32. The method of claim 31, wherein the step of distributing topics includes calculating if the duration of one or more of the topics is greater than a time allocated for a meeting agenda; and prompting a user to make a change to the length of one or more of the topics, the time allocated for the meeting agenda or removing one or more of the topics from the view of the mind map or a view of the agenda.

33. The method of claim 32, wherein, if the step of calculating calculates that the duration of all of the topics is less than the time allocated for the meeting agenda, then determining the remaining time of the meeting agenda not allocated to one or more of the topics.

34. The method of claim 33, further comprising determining if the remaining time is to be allocated automatically based on rules.

35. The method of claim 34, wherein if the remaining time is to be allocated automatically, then automatically adding time to particular ones of the plurality of topics based on the rules.

36. The method of claim 35, further comprising adjusting the meeting agenda.

37. The method of claim 36, wherein the step of adjusting the meeting agenda includes sorting fixed topics having a fixed start time from non-fixed topics having no fixed start time.

38. The method of claim 37, wherein the step of adjusting the meeting agenda includes:
sorting all of the fixed topics in order according to fixed start time;
if any non-fixed topics overlap any fixed topics, then determining if the non-fixed topics may be split based on the rules, and splitting those non-fixed topics that may be split based on the rules and moving the non-fixed topics or split portions thereof to start after an end time of one of the fixed topics;
comparing a start time assigned to a first topic of the plurality of topics in the meeting agenda and a start time for the meeting, and if the start time assigned to the first topic begins after the start time for the meeting, then if the start time assigned to the first topic may be changed to the meeting start time, changing the start time assigned to the first topic to the meeting start time, and if not, then if the duration between the meeting start time and the start time assigned to the first topic is sufficient to insert a non-fixed topic or portion thereof, if the non-fixed topic may be split based on the rules, then changing the start time of one of the non-fixed topics or portion thereof with a duration equal to or less than the duration between the meeting start time and the start time assigned to the first topic to the start time of the meeting, and otherwise, inserting a break between the meeting start time and the start time of the first topic.

39. The method of claim 38, wherein the step of adjusting the meeting agenda includes:
if a time gap exists between an end time of any one topic and the start time of another topic, then if the start time of the another topic may be changed based on the rules, changing the start time of the another topic to begin when the duration of the first topic ends, and if the start time of the another topic may not be changed based on the rules, then if the duration between the end time of the one topic and the start time assigned to another topic is sufficient to insert a non-fixed topic or portion thereof, if the non-fixed topic may be split based on the rules, then changing the start time of one of the non-fixed topics or portion thereof with a duration equal to or less than the duration between the end time of the one topic and the start time assigned to the another topic to the end time of the one topic; and otherwise, inserting a break between the one topic and the another topic.

40. The method of claim 39, wherein the step of adjusting the meeting agenda includes:
If a time gap exists between a non-fixed topic and a subsequent fixed topic, then if extending the duration of the non-fixed topic to end at the start time for the fixed topic is permitted, then extend the duration of the non-fixed topic to end at the start time for the fixed topic, and otherwise if there is time available in the meeting agenda for filling out the time gap, then inserting a break between the non-fixed topic and the subsequent fixed topic, or if there is not time available in the meeting agenda for filling out the gap, then taking a topic of another of the non-fixed topics or portion thereof, if another of the non-fixed topics may be split based on the rules, and changing the start time of the topic of the another of the non-fixed topics or portion thereof with a duration equal to or less than the duration between the end time of the non-fixed topic and the start time of the subsequent fixed topic to coincide with the end of the non-fixed topic.

41. The method of claim 36, further comprising, if any non-fixed topics have no value for duration specified, then if there is remaining time of the meeting agenda not allocated to one or more of the topics, distributing the remaining time among the non-fixed topics with no value for duration specified.

42. The method of claim 41, wherein if there is no remaining time of the meeting agenda not allocated to one or more topics and any non-fixed topics have no value for duration specified, then if sufficient time may be taken from other non-fixed topics with a duration specified according to the rules, then release from the other non-fixed topics with a duration specified the time needed for non-fixed topics with no duration specified and allocate the amount of time released among the non-fixed topics with no duration specified, or if sufficient time may not be taken from other non-fixed topics with a duration specified based on rules of the system, then release from the fixed topics, if any fixed topics have time that may be released based on the rules, time and allocate the amount of time released among the non-fixed topics with no duration specified based on rules of the system; or otherwise, if sufficient time is not available from the non-fixed topics with a duration specified and the fixed topics having time that may be released based on the rules, then notify the user that there is insufficient time for all of the topics to be scheduled.

43. The method of claim 36, further comprising optimizing the meeting agenda after the meeting agenda has been created or edited.

44. The method of claim 36, further comprising automatically generating a dashboard chart including information relating to the meeting agenda, the plurality of tasks, conduct of a meeting using the meeting agenda and feedback obtained after conduct of the meeting; and providing a dashboard chart display to a user of the system of claim 1.

45. The method of claim 44, wherein the user is the organizer of the meeting agenda.

46. The method of claim 28, further comprising conducting a meeting using the meeting agenda; and capturing data on the meeting during conduct of the meeting.

47. The method of claim 46, further comprising parking a topic, during the step of conducting a meeting, such that information related to the topic is flagged as saved in a parking lot or is saved in a database flagged as a parking lot database, wherein the topic or portion thereof is available during creation of a new meeting agenda or during editing of a different saved meeting agenda.

48. The method of claim 47, further comprising saving a topic, after completion of a meeting, such that information related to the topic is flagged as a past meeting topic or is saved in a database flagged as a past meeting database, wherein the topic or portion thereof is available during creation of a new meeting agenda or during editing of a different saved meeting agenda.

49. The method of claim 46, further comprising saving a topic, after completion of a meeting, such that information related to the topic is flagged as a past meeting topic or is saved in a database flagged as a past meeting database, wherein the topic or portion thereof is available during creation of a new meeting agenda or during editing of a different saved meeting agenda.
